(19) United States
(12) Patent Application Publication
(10) Pub. No.: US 2025/0323815 A1
(43) Pub. Date: Oct. 16, 2025

(54) DFT PHASE ROTATED PERMUTATION BASED OFDM

(71) Applicant: Samsung Electronics Co., Ltd., Suwon-si (KR)

(72) Inventors: Nuwan S. Ferdinand, Stittsville (CA); Joonyoung Cho, Portland, OR (US); Jianzhong Zhang, Dallas, TX (US)

(21) Appl. No.: 19/041,707

(22) Filed: Jan. 30, 2025

Related U.S. Application Data
(60) Provisional application No. 63/632,885, filed on Apr. 11, 2024.

(51) Int. Cl. H04L 27/26

(52) U.S. Cl. CPC H04L 27/2651; H04L 27/2607; H04L 27/2636

(57) ABSTRACT

Methods and apparatuses for discrete Fourier transform phase rotated permutation based orthogonal frequency division multiplexing (DFT-p-OFDM). An electronic device includes a processor configured to generate an input symbol vector of length M, and generate, from the input symbol vector, based on a first parameter c, a DFT-p-OFDM waveform. The electronic device also includes a transceiver operably coupled to the processor. The transceiver is configured to transmit the DFT-p-OFDM waveform.

### CROSS-REFERENCE TO RELATED APPLICATION(S) AND CLAIM OF PRIORITY

This application claims priority under 35 U.S.C. § 119(e) to U.S. Provisional Patent Application No. 63/632,885 filed on Apr. 11, 2024. The above-identified provisional patent application is hereby incorporated by reference in its entirety.

### TECHNICAL FIELD

This disclosure relates generally to wireless networks. More specifically, this disclosure relates to discrete Fourier transform (DFT) phase rotated permutation based orthogonal frequency division multiplexing (OFDM).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for DFT phase rotated permutation based OFDM.

In one embodiment, an electronic device is provided. The electronic device includes a processor. The processor is configured to generate an input symbol vector of length M, and generate, from the input symbol vector, based on a first parameter c, a discrete Fourier transform-phase rotated permutation-orthogonal frequency division multiplexing (DFT-p-OFDM) waveform. The electronic device also includes a transceiver operably coupled to the processor. The transceiver is configured to transmit the DFT-p-OFDM waveform.

In another embodiment, a method of operating an electronic device is proved. The method includes generating an input symbol vector of length M, and generating, from the input symbol vector, based on a first parameter c, a DFT-p-OFDM waveform. The method also includes transmitting the DFT-p-OFDM waveform.

In yet another embodiment, a non-transitory computer readable medium embodying a computer program is provided. The computer program includes program code that, when executed by a processor of a device, causes the device to generate an input symbol vector of length M, generate, from the input symbol vector, based on a first parameter c, a DFT-p-OFDM waveform, and transmit the DFT-p-OFDM waveform.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example transmitter according to embodiments of the present disclosure;

FIG. 5 illustrates an example procedure for operation of a transmitter according to embodiments of the present disclosure;

FIG. 6 illustrates a block diagram for waveform multiplexing according to embodiments of the present disclosure;

FIG. 7 illustrates an example procedure for operation of a transmitter according to embodiments of the present disclosure;

FIG. 8 illustrates an example phase rotated matrix according to embodiments of the present disclosure;

FIGS. 9A-9B illustrate another example phase rotated matrix according to embodiments of the present disclosure;

FIG. 10 illustrates an example procedure for downlink signaling according to embodiments of the present disclosure;

FIG. 11 illustrates an example procedure for uplink signaling according to embodiments of the present disclosure;

FIG. 12 illustrates another example procedure for downlink signaling according to embodiments of the present disclosure;

FIG. 13 illustrates another example procedure for uplink signaling according to embodiments of the present disclosure; and

FIG. 14 illustrates an example method for DFT phase rotated permutation based OFDM according to embodiments of the present disclosure.

### DETAILED DESCRIPTION

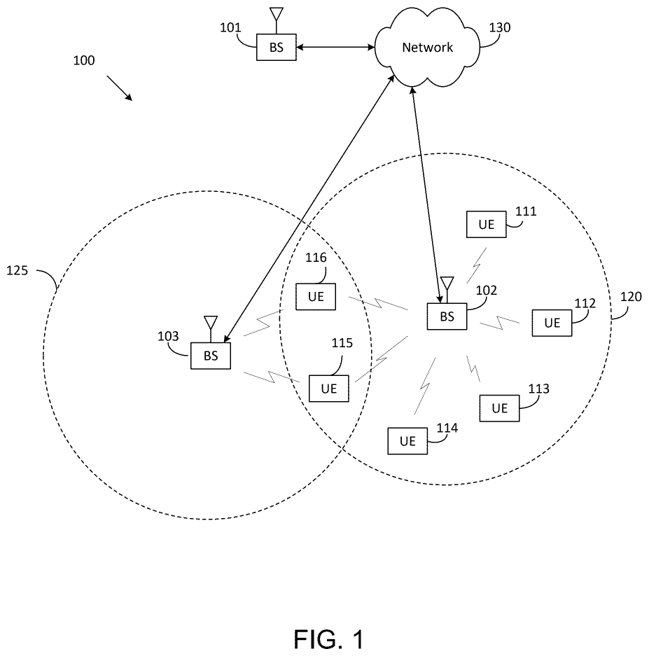

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for DFT phase rotated permutation based OFDM. In certain embodiments, one or more of the gNBs 101-103 includes circuitry, programing, or a combination thereof, to support DFT phase rotated permutation based OFDM in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

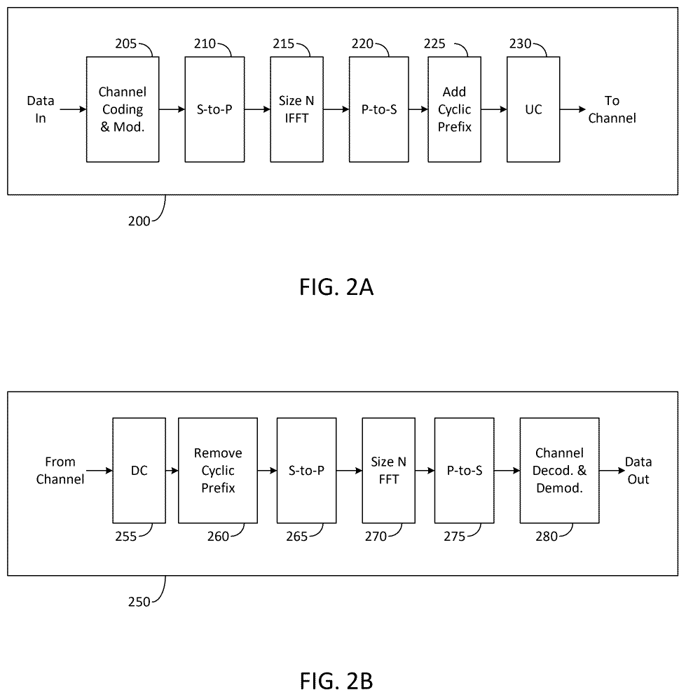

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support DFT phase rotated permutation based OFDM as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

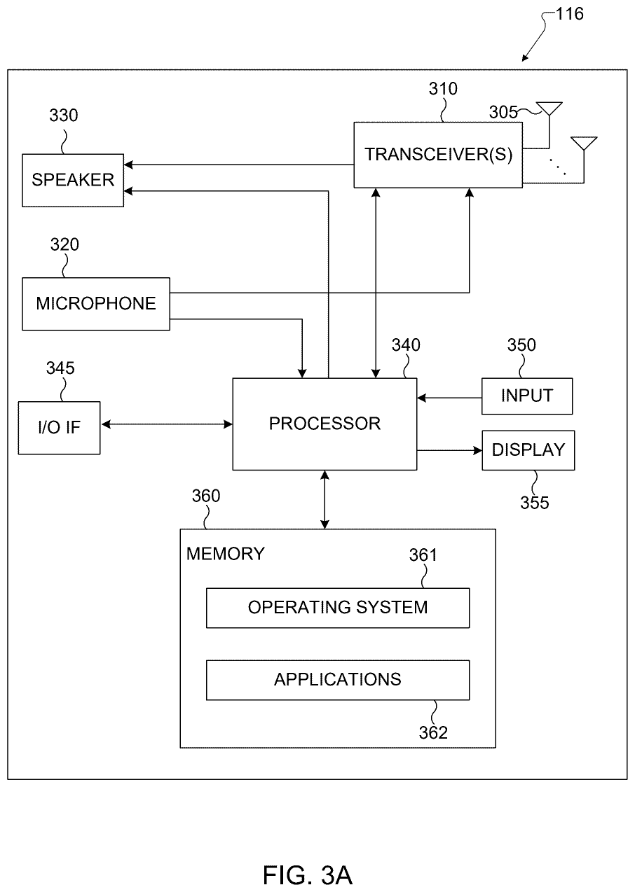

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for DFT phase rotated permutation based OFDM as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support DFT phase rotated permutation based OFDM as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In high mobility scenarios, the Doppler frequency significantly impacts the link level performance. In 5G NR two waveforms are used: orthogonal frequency division multiplexing (OFDM) and discrete Fourier transform (DFT) spread OFDM (DFT-s-OFDM). In the presence of doubly selective channels, such as high mobility applications, these two waveforms have significantly poor link level performance. A new waveform that can handle high mobility applications is desirable. It is further desirable for the new waveform to be compatible with the existing OFDM framework and with the ability to implement with the same complexity order. Various embodiments of the present disclosure provide for a new waveform according to the above.

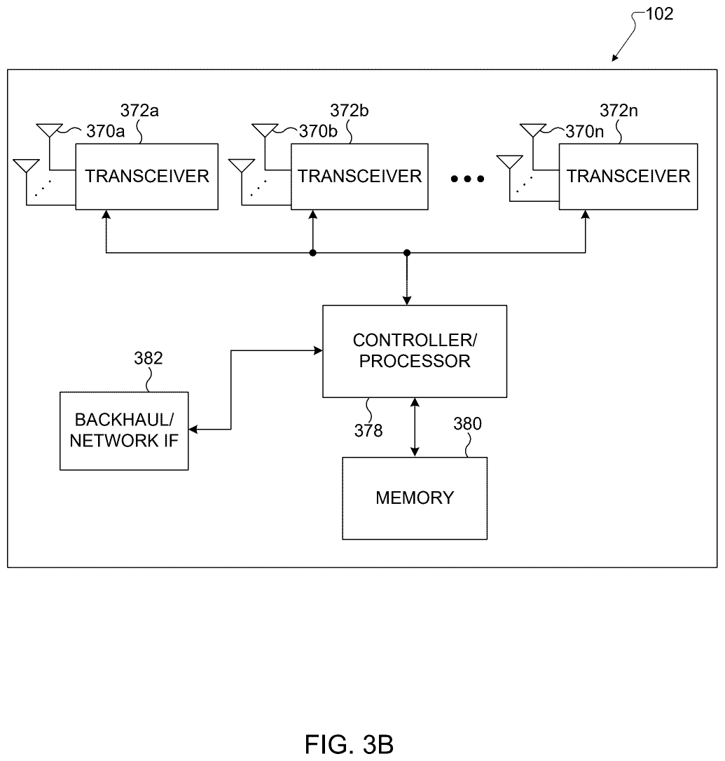

In some embodiments, such as the transmitter shown if FIG. 4, a discrete Fourier transform-phase rotated permutation-orthogonal frequency division (DFT-p-OFDM) waveform is provided which can perform well in doubly selective channels. In these embodiments, the DFT-p-OFDM waveform is based on an OFDM implementation with additional pre-processing that includes DFT and phase rotated permutation, and is based on the principle of discrete affine Fourier transform. The DFT-p-OFDM waveform of these embodiments can be multiplexed with OFDM waveforms in a UE specific manner, and can be implemented in the same complexity order as OFDM/DFT-s-OFDM.

FIG. 4 illustrates an example transmitter 400 according to embodiments of the present disclosure. The embodiment of a transmitter of FIG. 4 is for illustration only. Different embodiments of a transmitter could be used without departing from the scope of this disclosure.

In the example of FIG. 4, it should be understood that in some embodiments, transmitter 400 may be combined with or replace one or more components of transmit path 200 of FIG. 2A in a UE or a gNB. In some embodiments, one or more components of transmitter 400 may be implemented in a processor.

Transmitter 400 includes a discrete Fourier transform (DFT) block 405, a phase rotated permutation block 410, a subcarrier mapping block 415, an inverse discrete Fourier transform (IDFT) block 420, and an add cyclic prefix (CP) block 425.

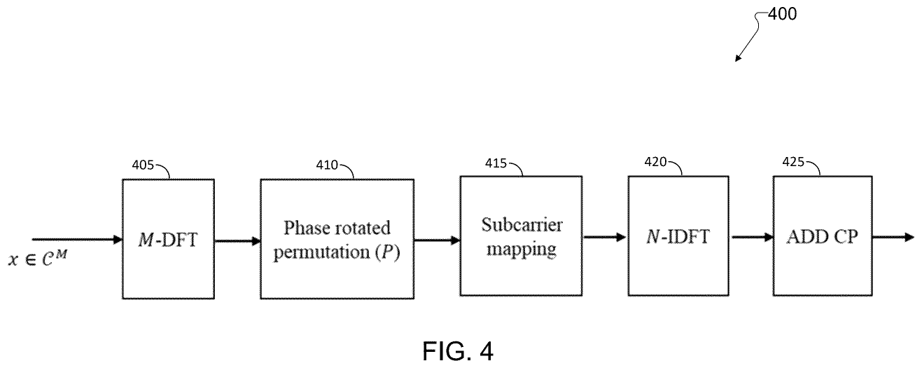

In transmitter 400, the DFT block 405 receives as input an M length symbol vector x∈E C^{M} which is formed using complex symbols. In general, the vector is complex, but can be real or imaginary in some circumstances, such as binary phase shift keying (BPSK) modulation. In some embodiments, the symbols can be generated from BPSK, π/2 BPSK, QPSK or QAM modulation. The DFT block 405 transforms the input into the frequency domain using a DFT operation, similar as described regarding step 510 of FIG. 5. The phase rotated permutation block 410, phase rotates and permutes the output of block 405, similar as described regarding step 520 of FIG. 5. Subcarrier mapping block 415 maps the output from block 410 to subcarriers, similar as described regarding step 530 of FIG. 5. IDFT block 420 performs an inverse discrete Fourier transform on the output of block 415, similar as described regarding step 540 of FIG. 5. Add CP block 425 adds a cyclic prefix to the output of block 420, similar as described regarding step 550 of FIG. 5.

Although FIG. 4 illustrates an example transmitter 400, various changes may be made to FIG. 4. For example, while illustrated with discrete components, the various components of transmitter 400 could be combined into a single component, etc. according to particular needs. Furthermore, while described as being implemented in a transmitter, the operations of the various components of FIG. 4 may be performed by another device, such as a processor. For example, one or more of the operations performed by the components of FIG. 4 could be performed by processor 340 of FIG. 3A, or processor 378 of FIG. 3B.

FIG. 5 illustrates an example procedure 500 for operation of a transmitter according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for operation of a transmitter could be used without departing from the scope of this disclosure.

In the example of FIG. 5, procedure 500 for operation of a transmitter (such as transmitter 400 of FIG. 4) begins at operation 510. At operation 510, the input (e.g., an M length symbol vector x∈E C^{M}) is transformed (e.g., by block 405 of transmitter 400) into the frequency domain using a DFT operation. The DFT operation may be performed using an M sized FFT, generating a frequency domain M length sequence.

At operation 520, the frequency domain M length sequence is phase rotated and permuted (e.g., by block 410 of transmitter 400). The phase rotation has unit magnitude. Operation 504 can be performed via multiplying by an M×M phase rotated permutation matrix P. The matrix P is unitary such that PP^{H}=P^{H}P=I where I is the identity matrix.

At operation 530, the output of operation 520 is mapped (e.g., by block 415 of transmitter 400) to subcarriers. The subcarrier mapping operation can be performed using a matrix operation, where the input is multiplied by the subcarrier mapping matrix S, where S is a N×M matrix. For each column m∈{1, 2, . . . . M} of matrix S, there is only one nonzero element, which is equal to one, and located at nm such that nₘ≠n_{m̅} for m≠m̅. This way, the m^{th} element of input is mapped to a unique nₘ subcarrier. In some embodiments, the mapping is circularly contiguous such that the mapped subcarrier indexes are L to [L+M−1]_{N} where L∈{0, 1, 2, . . . N−1} and [⋅]_{N} denotes the N modulo operation such that [l+N]_{N}=l.

At the operation 540, an N sized inverse discrete Fourier transform is performed (e.g., by block 420 of transmitter 400) to the output from operation 530. Operation 540 may be performed using an N sized inverse FFT (IFFT) operation.

At the operation 550, a cyclic prefix is added (e.g., by block 425 of transmitter 400) to the N length signal output resulting from operation 540.

Although FIG. 5 illustrates one example procedure 500 for operation of a transmitter, various changes may be made to FIG. 5. For example, while shown as a series of operations, various operations in FIG. 5 could overlap, occur in parallel, occur in a different order, occur any number of times, be omitted, or replaced by other operations.

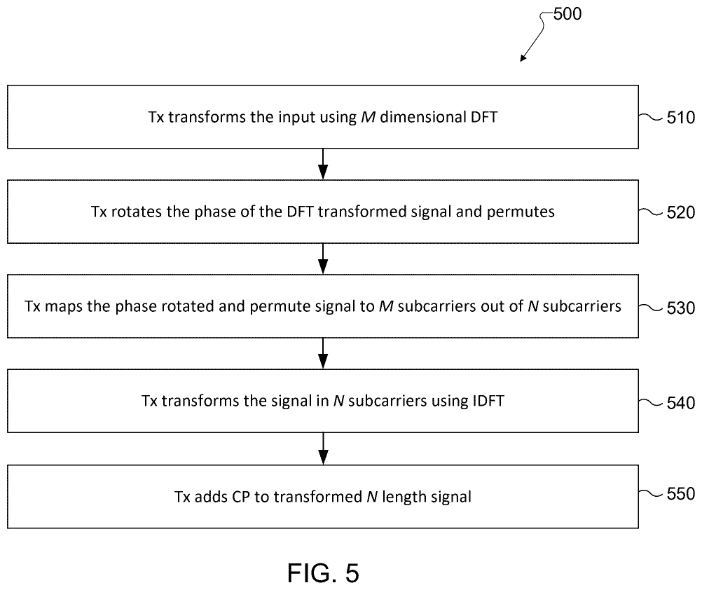

In some embodiments, such as shown in FIG. 6, different waveforms are multiplexed into an allocated bandwidth such that the waveforms are allocated distinct subcarriers and orthogonal to each other.

FIG. 6 illustrates a block diagram 600 for waveform multiplexing according to embodiments of the present disclosure. The embodiment of waveform multiplexing of FIG. 6 is for illustration only. Different embodiments of waveform multiplexing could be used without departing from the scope of this disclosure.

In the example of FIG. 6, it should be understood that in some embodiments, the blocks of block diagram 600 may be combined with or replace one or more components of transmit path 200 of FIG. 2A in a UE or a gNB. In some embodiments, one or more components of block diagram 600 may be implemented in a processor.

In the example of FIG. 6, the multiplexing of block diagram 600 is for downlink with k₁+k₂ receivers, out of which, k₁ receivers are based on the DFT-p-OFDM waveform described regarding FIG. 4 and FIG. 5, and k₂ receivers are based on OFDM.

As shown in FIG. 6, input symbols for transmission to the receivers have been separated into K different streams, where K=k₁+k₂ different streams and the kth separated sequence is of length Mₖ which corresponds to the kth receiver. These Mₖ∀k∈{1, K} length vectors comprise complex symbols. In general, however, the vectors can be real or imaginary. For example, these symbols can be generated from BPSK, π/2 BPSK, QPSK or QAM modulations.

Block diagram 600 includes k₁ discrete Fourier transform (DFT) blocks 605, k₁ phase rotated permutation blocks 610, a subcarrier mapping block 615, an inverse discrete Fourier transform (IDFT) block 620, and an add cyclic prefix (CP) block 625.

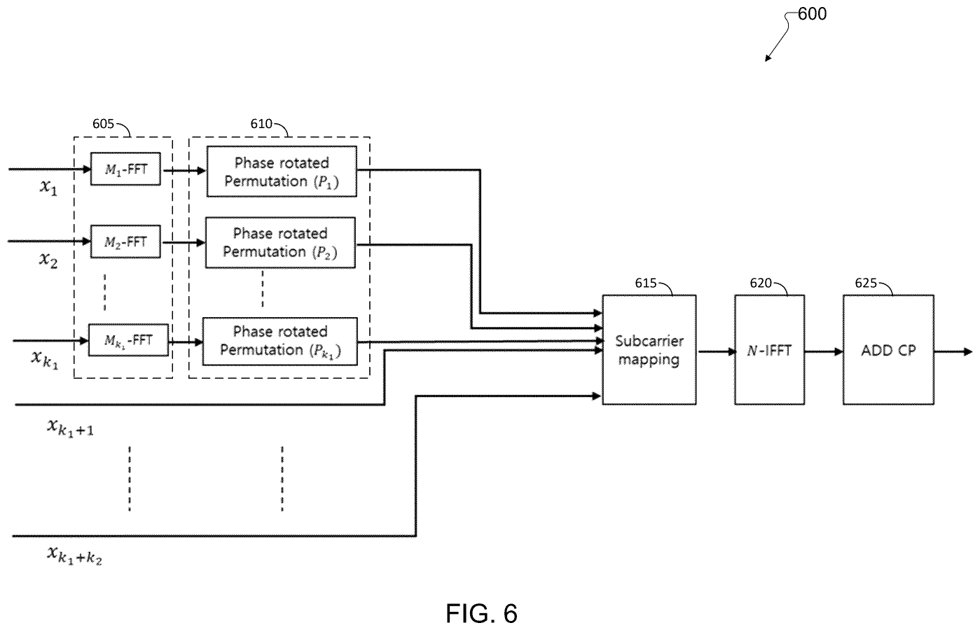

Each of the DFT blocks 605 transforms one of the k₁ input streams into the frequency domain using a DFT operation, similar as described regarding step 720 of FIG. 7. Each of the phase rotated permutation blocks 610, phase rotates and permutes the output of one of the blocks 605, similar as described regarding step 730 of FIG. 7. Subcarrier mapping block 615 maps the output from blocks 610 and the unprocessed k₂ input streams to subcarriers, similar as described regarding step 740 of FIG. 7. IDFT block 620 performs an inverse discrete Fourier transform on the output of block 615, similar as described regarding step 750 of FIG. 7. Add CP block 625 adds a cyclic prefix to the output of block 620, similar as described regarding step 760 of FIG. 7.

Although FIG. 6 illustrates an example block diagram 600 for waveform multiplexing, various changes may be made to FIG. 6. For example, while illustrated with discrete components, the various components of transmitter 600 could be combined into a single component, etc. according to particular needs. Furthermore, while described as being implemented in a transmitter, the operations of the various components of FIG. 6 may be performed by another device, such as a processor. For example, one or more of the operations performed by the components of FIG. 6 could be performed by processor 340 of FIG. 3A, or processor 378 of FIG. 3B.

FIG. 7 illustrates an example procedure 700 for operation of a transmitter according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for operation of a transmitter could be used without departing from the scope of this disclosure.

The operations in the example of procedure 700 are for waveform multiplexing by a transmitter for downlink with k₁+k₂ receivers, out of which, k₁ receivers are based on the DFT-p-OFDM waveform described regarding FIG. 4 and FIG. 5, and k₂ receivers are based on OFDM.

In the example of FIG. 7, procedure 700 begins at operation 710. At operation 710, the transmitter separates input symbols for transmission to the receivers into K different streams, where K=k₁+k₂ different streams and the k^{th} separated sequence is of length Mₖ which corresponds to the k^{th} receiver. These Mₖ∀k∈{1, K} length vectors comprise complex symbols. In general, however, the vectors can be real or imaginary. For example, these symbols can be generated from BPSK, π/2 BPSK, QPSK or QAM modulations.

At operation 720, the k₁ vectors are first transformed using DFT. For example, the k^{th}∀k∈{1, 2, . . . , k₁} vector of length Mₖ is transformed using Mₖ size DFT.

At operation 730, the DFT transformed signals are phase rotated and permuted by Pₖ where Pₖ is obtained using the same methods described above regarding operation 520 of FIG. 5. The Pₖ may be different for the different k₁ streams, or the Pₖ can be the same for a subset or for all of the different k₁ streams.

At operation 740, the DFT transformed, phased rotated, and permuted k₁ streams and unprocessed k₂ streams are mapped to subcarriers. In some embodiments, operation 740 may be performed when the following condition is be satisfied:

$${\sum }_{k}^{K} {M}_{k} \leq N$$

Then the k^{th} input is mapped to Mₖ subcarriers out of the total N subcarriers such that two inputs do not overlap and thus the orthogonality condition is satisfied. The subcarriers may be mapped contiguously such that the k^{th} input is mapped to subcarriers of indexes Lₖ to [Lₖ+Mₖ−1]_{N} where Lₖ∈{0, 1, 2, . . . N−1} and [⋅]_{N} denotes the N modulo operation such that [l+N]_{N}=l.

At operation 750, the subcarrier mapped signal is transformed using an N sized inverse Fourier transform.

At operation 760, a cyclic prefix is added at the beginning of the N samples.

Although FIG. 7 illustrates one example procedure 700 for operation of a transmitter, various changes may be made to FIG. 7. For example, while shown as a series of operations, various operations in FIG. 7 could overlap, occur in parallel, occur in a different order, occur any number of times, be omitted, or replaced by other operations.

The latter parts of the embodiments illustrated in FIG. 6 and FIG. 7 demonstrate that different waveforms can be multiplexed together. The waveform information that was used by the transmitter is utilized at the receiver(s) in order to function properly. The waveform information can be communicated to the receiver(s) via control signaling. A new field may be added to the existing control signaling such that the control signaling indicates what type of waveform is used. In particular, if two waveforms are used such as the DFT-p-OFDM waveform described herein and an OFDM waveform, then one bit can be used to distinguish the two waveforms. Table 1 specifies an example operation of a bit function wₖ to distinguish two waveforms.

TABLE 1
Waveform identification table

| Bit sequence wₖ | Waveform |
|---|---|
| 0 | OFDM |
| 1 | DFT-p-OFDM |

In the 3GPP specification, a new field may be created for the bit sequence wₖ and the new field can be contained in downlink control information (DCI)/uplink control information (UCI) or other signaling methods such as radio resource control (RRC), MAC-CE (Control Element)

In some embodiments, the m^{th} row (m∈{0, 1, . . . , M−1}) and l^{th} column (l∈{0, 1, . . . , M−1}) of a phase rotated permutation matrix P (such as described regarding operation 520 of FIG. 5) may be given by:

$${P}_{m l} = \frac{1}{M √ M} {\sum }_{k = 0}^{M - 1} {\sum }_{n = 0}^{M - 1} exp ( j 2 π ( \frac{- 2 km + c {k}^{2} + 2 nk + c {n}^{2} + 2 nl}{2 M} ) )$$

In these embodiments, the parameter c is chosen such that P is a unitary phase rotated permutation matrix such that in each row and each column, there is only one non-zero element in P and this non-zero element is a unit norm complex exponential. The parameter c defines different realizations of P. In the matrix form, P is given by

$$P = {F}_{M} {Λ}_{c}^{H} {F}_{M}^{H} {Λ}_{c}^{H} {F}_{M}^{H}$$

where the F_{M} denotes the M×M discrete Fourier transform matrix and

$${F}_{M}^{H}$$

is the M×M inverse discrete Fourier transform matrix. Further

$${Λ}_{c}^{H}$$

is the Hermitian of Λ_{c}, and Λc is diagonal matrix such that the m^{th} diagonal element is given by e^{-i2πcm}^{²}^{/2M} where m∈{1, 2, . . . , M}.

The parameter c may satisfy the following conditions such that P is a phase rotated unitary permutation matrix:
The parameter c is an integer
The parameter c is a coprime with M

Once the parameter c is found, the phase rotated permutation matrix P can be obtained.

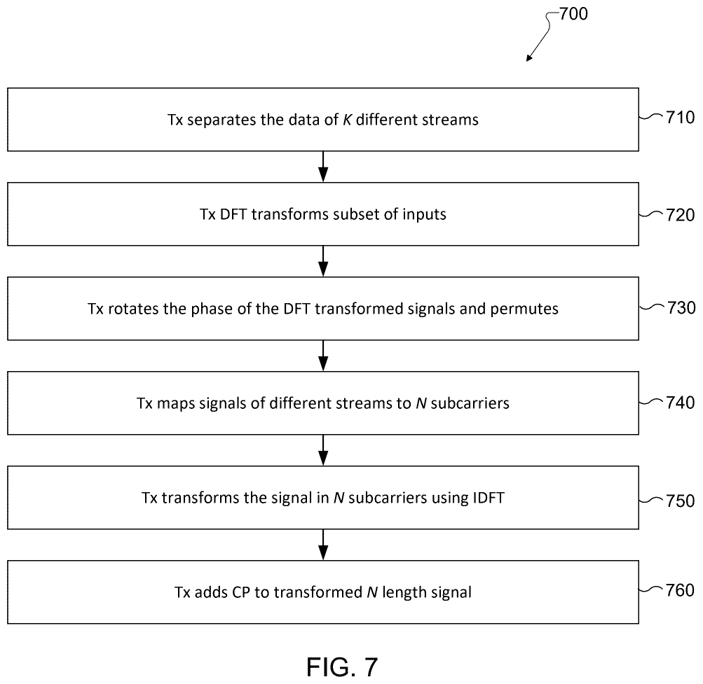

In some embodiments, the set of c parameters may be found using a non-zero condition. For example, if P is a phase rotated permutation matrix, P can have only one non-zero value in each row and each column. An example is shown in FIG. 8. where the dark black square represents the non-zero value of each row of P.

FIG. 8 illustrates an example phase rotated matrix 800 according to embodiments of the present disclosure. The embodiment of a phase rotated of FIG. 8 is for illustration only. Different embodiments of a phase rotated matrix could be used without departing from the scope of this disclosure.

In the example of FIG. 8, the dark black square in each row of P represents the non-zero value of the respective row of P.

Although FIG. 8 illustrates an example phase rotated matrix 800, various changes may be made to FIG. 8. For example, various changes to locations of the non-zero values could be made, etc. according to particular needs.

For any given row m, the Pₘₗ≠0 for only one value of l∈{0 . . . , M−1}. Thus, in order to find the c, any row m∈{0, . . . , M−1} can be chosen and for simplicity, m=0 can be chosen. This approach is detailed as follows:

Find the integer c∈{1, 2, . . . , 2M−1} such that P₀ₗ is non-zero for only one value of l∈{0, 1, . . . , M−1} where

$${P}_{0 l} = \frac{1}{M √ M} {\sum }_{k = 0}^{M - 1} {\sum }_{n = 0}^{M - 1} exp ( j 2 π ( \frac{{c ( k + n )}^{2} + 2 n ( l + k ( 1 - c ) )}{2 M} ) )$$

In some embodiments, P is designed to be a unitary matrix. In these embodiments, PP^{H}=P^{H}P=I. P satisfies this property when:

$${\sum }_{l = 0}^{M - 1} {\vert {P}_{m l} \vert}^{2} = 1 , ∀ m ∈ \{ 0 , 1 , … , M - 1 \}$$

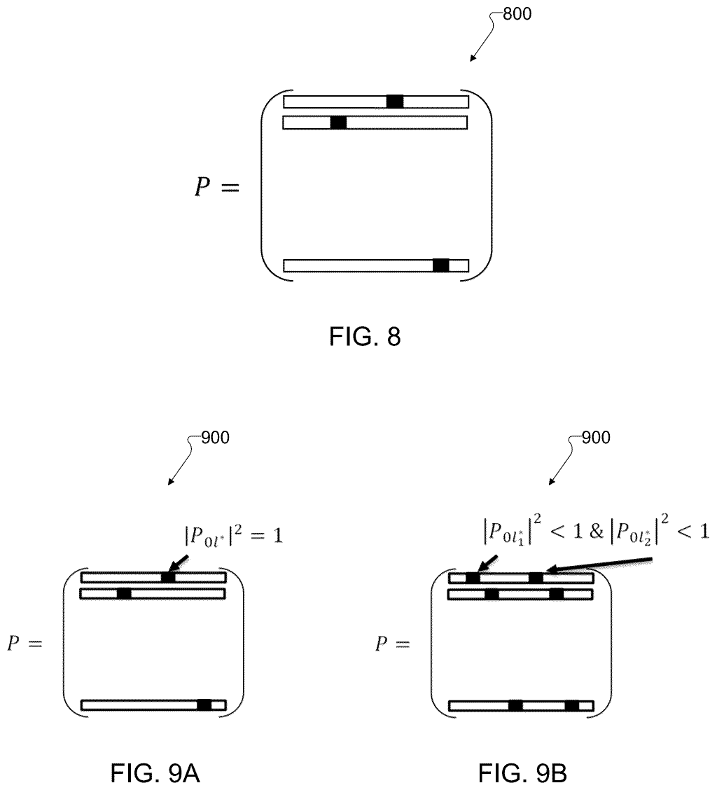

If P has only one non-zero element in each row, then the absolute value of that element should be equal to 1. However, if it has more than one non-zero elements, then the absolute value of those elements should be less than 1 in order to satisfy the above condition. An example is shown in FIGS. 9A-9B.

FIGS. 9A-9B illustrate another example phase rotated matrix 900 according to embodiments of the present disclosure. The embodiment of a phase rotated matrix of FIGS. 9A-9B is for illustration only. Different embodiments of a phase rotated matrix could be used without departing from the scope of this disclosure.

In the example of FIGS. 9A-9B, the dark black squares in each row of P represents a non-zero value of the respective row of P. In the example of FIG. 9A, P has only one non-zero element in each row, and the absolute value of that element is equal to 1. In the example of FIG. 9B, P has multiple non-zero elements in each row, and the absolute value of these elements is less than 1.

Although FIGS. 9A-9B illustrate an example phase rotated matrix 900, various changes may be made to FIGS. 9A-9B. For example, various changes to locations of the non-zero values could be made, etc. according to particular needs.

Based on the above arguments, the following two methods can be used to find parameter c
The parameter c can be found such that for any l∈{0, 1, . . . , M−1}

$${\vert {P}_{0 l} \vert}^{2} = {\vert \frac{1}{M \sqrt{M}} {\sum }_{k = 0}^{M - 1} {\sum }_{n = 0}^{M - 1} exp ( j 2 π ( \frac{{c ( k + n )}^{2} + 2 n ( l + k ( 1 - c ) )}{2 M} ) ) \vert}^{2} = 1$$

Alternatively, the parameter c can be found using

$${c}^{*} = arg {max}_{c , ∀ l} {\vert {P}_{0 l} \vert}^{2}$$

The search space of c can be reduced by enforcing the following condition:
The parameter c⊂{1, 2, . . . , M−1} and c is a coprime with M.

In some embodiments, the desired values of the c are presented for a set of subcarriers M. For example, where a resource block (RB) be defined as 12 subcarriers, M=12×RB. In Table 2, the relevant c is given for 1RB to 275 RBs. The value of c is used to find the phase rotated permutation matrix P.

TABLE 2
Parameter c for IRB to 275 RBs

| RB | c parameters |
|---|---|
| 1 | 1, 5, 7, 11 |
| 2 | 1, 5, 7, 11, 13, 17, 19, 23 |
| 3 | 1, 17, 19, 35 |
| 4 | 1, 7, 17, 23, 25, 31, 41, 47 |
| 5 | 1, 11, 19, 29, 31, 41, 49, 59 |
| 6 | 1, 17, 19, 35, 37, 53, 55, 71 |
| 7 | 1, 13, 29, 41, 43, 55, 71, 83 |
| 8 | 1, 17, 31, 47, 49, 65, 79, 95 |
| 9 | 1, 53, 55, 107 |
| 10 | 1, 11, 19, 29, 31, 41, 49, 59, 61, 71, 79, 89, 91, 101, |
| | 109, 119 |
| 11 | 1, 23, 43, 65, 67, 89, 109, 131 |
| 12 | 1, 17, 55, 71, 73, 89, 127, 143 |
| 13 | 1, 25, 53, 77, 79, 103, 131, 155 |
| 14 | 1, 13, 29, 41, 43, 55, 71, 83, 85, 97, 113, 125, 127, 139, |
| | 155, 167 |
| 15 | 1, 19, 71, 89, 91, 109, 161, 179 |
| 16 | 1, 31, 65, 95, 97, 127, 161, 191 |
| 17 | 1, 35, 67, 101, 103, 137, 169, 203 |
| 18 | 1, 53, 55, 107, 109, 161, 163, 215 |
| 19 | 1, 37, 77, 113, 115, 151, 191, 227 |
| 20 | 1, 31, 41, 49, 71, 79, 89, 119, 121, 151, 161, 169, 191, |
| | 199, 209, 239 |
| 21 | 1, 55, 71, 125, 127, 181, 197, 251 |
| 22 | 1, 23, 43, 65, 67, 89, 109, 131, 133, 155, 175, 197, 199, |
| | 221, 241, 263 |
| 23 | 1, 47, 91, 137, 139, 185, 229, 275 |
| 24 | 1, 17, 127, 143, 145, 161, 271, 287 |
| 25 | 1, 49, 101, 149, 151, 199, 251, 299 |
| 26 | 1, 25, 53, 77, 79, 103, 131, 155, 157, 181, 209, 233, 235, |
| | 259, 287, 311 |
| 27 | 1, 161, 163, 323 |
| 28 | 1, 41, 55, 71, 97, 113, 127, 167, 169, 209, 223, 239, 265, |
| | 281, 295, 335 |
| 29 | 1, 59, 115, 173, 175, 233, 289, 347 |
| 30 | 1, 19, 71, 89, 91, 109, 161, 179, 181, 199, 251, 269, 271, |
| | 289, 341, 359 |
| 31 | 1, 61, 125, 185, 187, 247, 311, 371 |
| 32 | 1, 65, 127, 191, 193, 257, 319, 383 |
| 33 | 1, 89, 109, 197, 199, 287, 307, 395 |
| 34 | 1, 35, 67, 101, 103, 137, 169, 203, 205, 239, 271, 305, 307, |
| | 341, 373, 407 |
| 35 | 1, 29, 41, 71, 139, 169, 181, 209, 211, 239, 251, 281, 349, |
| | 379, 391, 419 |
| 36 | 1, 55, 161, 215, 217, 271, 377, 431 |
| 37 | 1, 73, 149, 221, 223, 295, 371, 443 |
| 38 | 1, 37, 77, 113, 115, 151, 191, 227, 229, 265, 305, 341, 343, |
| | 379, 419, 455 |
| 39 | 1, 53, 181, 233, 235, 287, 415, 467 |
| 40 | 1, 31, 49, 79, 161, 191, 209, 239, 241, 271, 289, 319, 401, |
| | 431, 449, 479 |
| 41 | 1, 83, 163, 245, 247, 329, 409, 491 |
| 42 | 1, 55, 71, 125, 127, 181, 197, 251, 253, 307, 323, 377, 379, |
| | 433, 449, 503 |
| 43 | 1, 85, 173, 257, 259, 343, 431, 515 |
| 44 | 1, 23, 65, 89, 175, 199, 241, 263, 265, 287, 329, 353, 439, |
| | 463, 505, 527 |
| 45 | 1, 109, 161, 269, 271, 379, 431, 539 |
| 46 | 1, 47, 91, 137, 139, 185, 229, 275, 277, 323, 367, 413, 415, |
| | 461, 505, 551 |
| 47 | 1, 95, 187, 281, 283, 377, 469, 563 |
| 48 | 1, 127, 161, 287, 289, 415, 449, 575 |
| 49 | 1, 97, 197, 293, 295, 391, 491, 587 |
| 50 | 1, 49, 101, 149, 151, 199, 251, 299, 301, 349, 401, 449, |
| | 451, 499, 551, 599 |
| 51 | 1, 35, 271, 305, 307, 341, 577, 611 |
| 52 | 1, 25, 79, 103, 209, 233, 287, 311, 313, 337, 391, 415, |
| | 521, 545, 599, 623 |
| 53 | 1, 107, 211, 317, 319, 425, 529, 635 |
| 54 | 1, 161, 163, 323, 325, 485, 487, 647 |
| 55 | 1, 89, 109, 131, 199, 221, 241, 329, 331, 419, 439, 461, |
| | 529, 551, 571, 659 |
| 56 | 1, 97, 113, 127, 209, 223, 239, 335, 337, 433, 449, 463, |
| | 545, 559, 575, 671 |
| 57 | 1, 37, 305, 341, 343, 379, 647, 683 |
| 58 | 1, 59, 115, 173, 175, 233, 289, 347, 349, 407, 463, 521, |
| | 523, 581, 637, 695 |
| 59 | 1, 119, 235, 353, 355, 473, 589, 707 |
| 60 | 1, 71, 89, 161, 199, 271, 289, 359, 361, 431, 449, 521, |
| | 559, 631, 649, 719 |
| 61 | 1, 121, 245, 365, 367, 487, 611, 731 |
| 62 | 1, 61, 125, 185, 187, 247, 311, 371, 373, 433, 497, 557, |
| | 559, 619, 683, 743 |
| 63 | 1, 55, 323, 377, 379, 433, 701, 755 |
| 64 | 1, 127, 257, 383, 385, 511, 641, 767 |
| 65 | 1, 79, 131, 181, 209, 259, 311, 389, 391, 469, 521, 571, |
| | 599, 649, 701, 779 |
| 66 | 1, 89, 109, 197, 199, 287, 307, 395, 397, 485, 505, 593, |
| | 595, 683, 703, 791 |
| 67 | 1, 133, 269, 401, 403, 535, 671, 803 |
| 68 | 1, 103, 137, 169, 239, 271, 305, 407, 409, 511, 545, 577, |
| | 647, 679, 713, 815 |
| 69 | 1, 91, 323, 413, 415, 505, 737, 827 |
| 70 | 1, 29, 41, 71, 139, 169, 181, 209, 211, 239, 251, 281, |
| | 349, 379, 391, 419, 421, 449, 461, 491, 559, 589, 601, |
| | 629, 631, 659, 671, 701, 769, 799, 811, 839 |
| 71 | 1, 143, 283, 425, 427, 569, 709, 851 |
| 72 | 1, 161, 271, 431, 433, 593, 703, 863 |
| 73 | 1, 145, 293, 437, 439, 583, 731, 875 |
| 74 | 1, 73, 149, 221, 223, 295, 371, 443, 445, 517, 593, 665, |
| | 667, 739, 815, 887 |
| 75 | 1, 199, 251, 449, 451, 649, 701, 899 |
| 76 | 1, 113, 151, 191, 265, 305, 343, 455, 457, 569, 607, 647, |
| | 721, 761, 799, 911 |
| 77 | 1, 43, 155, 197, 265, 307, 419, 461, 463, 505, 617, 659, |
| | 727, 769, 881, 923 |
| 78 | 1, 53, 181, 233, 235, 287, 415, 467, 469, 521, 649, 701, |
| | 703, 755, 883, 935 |
| 79 | 1, 157, 317, 473, 475, 631, 791, 947 |
| 80 | 1, 31, 161, 191, 289, 319, 449, 479, 481, 511, 641, 671, |
| | 769, 799, 929, 959 |
| 81 | 1, 485, 487, 971 |
| 82 | 1, 83, 163, 245, 247, 329, 409, 491, 493, 575, 655, 737, |
| | 739, 821, 901, 983 |
| 83 | 1, 167, 331, 497, 499, 665, 829, 995 |
| 84 | 1, 55, 71, 127, 377, 433, 449, 503, 505, 559, 575, 631, |
| | 881, 937, 953, 1007 |
| 85 | 1, 101, 169, 239, 271, 341, 409, 509, 511, 611, 679, 749, |
| | 781, 851, 919, 1019 |
| 86 | 1, 85, 173, 257, 259, 343, 431, 515, 517, 601, 689, 773, |
| | 775, 859, 947, 1031 |
| 87 | 1, 233, 289, 521, 523, 755, 811, 1043 |
| 88 | 1, 65, 175, 241, 287, 353, 463, 527, 529, 593, 703, 769, |
| | 815, 881, 991, 1055 |
| 89 | 1, 179, 355, 533, 535, 713, 889, 1067 |
| 90 | 1, 109, 161, 269, 271, 379, 431, 539, 541, 649, 701, 809, |
| | 811, 919, 971, 1079 |
| 91 | 1, 155, 181, 209, 337, 365, 391, 545, 547, 701, 727, 755, |
| | 883, 911, 937, 1091 |
| 92 | 1, 47, 137, 185, 367, 415, 505, 551, 553, 599, 689, 737, |
| | 919, 967, 1057, 1103 |
| 93 | 1, 125, 433, 557, 559, 683, 991, 1115 |
| 94 | 1, 95, 187, 281, 283, 377, 469, 563, 565, 659, 751, 845, |
| | 847, 941, 1033, 1127 |
| 95 | 1, 151, 191, 229, 341, 379, 419, 569, 571, 721, 761, 799, |
| | 911, 949, 989, 1139 |
| 96 | 1, 127, 449, 575, 577, 703, 1025, 1151 |
| 97 | 1, 193, 389, 581, 583, 775, 971, 1163 |
| 98 | 1, 97, 197, 293, 295, 391, 491, 587, 589, 685, 785, 881, |
| | 883, 979, 1079, 1175 |
| 99 | 1, 109, 485, 593, 595, 703, 1079, 1187 |
| 100 | 1, 49, 151, 199, 401, 449, 551, 599, 601, 649, 751, 799, |
| | 1001, 1049, 1151, 1199 |
| 101 | 1, 203, 403, 605, 607, 809, 1009, 1211 |
| 102 | 1, 35, 271, 305, 307, 341, 577, 611, 613, 647, 883, 917, |
| | 919, 953, 1189, 1223 |
| 103 | 1, 205, 413, 617, 619, 823, 1031, 1235 |
| 104 | 1, 79, 209, 287, 337, 415, 545, 623, 625, 703, 833, 911, |
| | 961, 1039, 1169, 1247 |
| 105 | 1, 71, 181, 251, 379, 449, 559, 629, 631, 701, 811, 881, |
| | 1009, 1079, 1189, 1259 |
| 106 | 1, 107, 211, 317, 319, 425, 529, 635, 637, 743, 847, 953, |
| | 955, 1061, 1165, 1271 |
| 107 | 1, 215, 427, 641, 643, 857, 1069, 1283 |
| 108 | 1, 161, 487, 647, 649, 809, 1135, 1295 |
| 109 | 1, 217, 437, 653, 655, 871, 1091, 1307 |
| 110 | 1, 89, 109, 131, 199, 221, 241, 329, 331, 419, 439, 461, |
| | 529, 551, 571, 659, 661, 749, 769, 791, 859, 881, 901, |
| | 989, 991, 1079, 1099, 1121, 1189, 1211, 1231, 1319 |
| 111 | 1, 73, 593, 665, 667, 739, 1259, 1331 |
| 112 | 1, 97, 127, 223, 449, 545, 575, 671, 673, 769, 799, 895, |
| | 1121, 1217, 1247, 1343 |
| 113 | 1, 227, 451, 677, 679, 905, 1129, 1355 |
| 114 | 1, 37, 305, 341, 343, 379, 647, 683, 685, 721, 989, 1025, |
| | 1027, 1063, 1331, 1367 |
| 115 | 1, 91, 139, 229, 461, 551, 599, 689, 691, 781, 829, 919, |
| | 1151, 1241, 1289, 1379 |
| 116 | 1, 175, 233, 289, 407, 463, 521, 695, 697, 871, 929, 985, |
| | 1103, 1159, 1217, 1391 |
| 117 | 1, 53, 649, 701, 703, 755, 1351, 1403 |
| 118 | 1, 119, 235, 353, 355, 473, 589, 707, 709, 827, 943, 1061, |
| | 1063, 1181, 1297, 1415 |
| 119 | 1, 169, 239, 307, 407, 475, 545, 713, 715, 883, 953, 1021, |
| | 1121, 1189, 1259, 1427 |
| 120 | 1, 161, 271, 289, 431, 449, 559, 719, 721, 881, 991, 1009, |
| | 1151, 1169, 1279, 1439 |
| 121 | 1, 241, 485, 725, 727, 967, 1211, 1451 |
| 122 | 1, 121, 245, 365, 367, 487, 611, 731, 733, 853, 977, 1097, |
| | 1099, 1219, 1343, 1463 |
| 123 | 1, 163, 575, 737, 739, 901, 1313, 1475 |
| 124 | 1, 185, 247, 311, 433, 497, 559, 743, 745, 929, 991, 1055, |
| | 1177, 1241, 1303, 1487 |
| 125 | 1, 251, 499, 749, 751, 1001, 1249, 1499 |
| 126 | 1, 55, 323, 377, 379, 433, 701, 755, 757, 811, 1079, 1133, |
| | 1135, 1189, 1457, 1511 |
| 127 | 1, 253, 509, 761, 763, 1015, 1271, 1523 |
| 128 | 1, 257, 511, 767, 769, 1025, 1279, 1535 |
| 129 | 1, 343, 431, 773, 775, 1117, 1205, 1547 |
| 130 | 1, 79, 131, 181, 209, 259, 311, 389, 391, 469, 521, 571, 599, |
| | 649, 701, 779, 781, 859, 911, 961, 989, 1039, 1091, 1169, 1171, |
| | 1249, 1301, 1351, 1379, 1429, 1481, 1559 |
| 131 | 1, 263, 523, 785, 787, 1049, 1309, 1571 |
| 132 | 1, 89, 199, 287, 505, 593, 703, 791, 793, 881, 991, 1079, 1297, |
| | 1385, 1495, 1583 |
| 133 | 1, 113, 265, 379, 419, 533, 685, 797, 799, 911, 1063, 1177, |
| | 1217, 1331, 1483, 1595 |
| 134 | 1, 133, 269, 401, 403, 535, 671, 803, 805, 937, 1073, 1205, |
| | 1207, 1339, 1475, 1607 |
| 135 | 1, 161, 649, 809, 811, 971, 1459, 1619 |
| 136 | 1, 239, 271, 305, 511, 545, 577, 815, 817, 1055, 1087, 1121, |
| | 1327, 1361, 1393, 1631 |
| 137 | 1, 275, 547, 821, 823, 1097, 1369, 1643 |
| 138 | 1, 91, 323, 413, 415, 505, 737, 827, 829, 919, 1151, 1241, |
| | 1243, 1333, 1565, 1655 |
| 139 | 1, 277, 557, 833, 835, 1111, 1391, 1667 |
| 140 | 1, 41, 71, 169, 209, 239, 281, 391, 449, 559, 601, 631, 671, |
| | 769, 799, 839, 841, 881, 911, 1009, 1049, 1079, 1121, 1231, |
| | 1289, 1399, 1441, 1471, 1511, 1609, 1639, 1679 |
| 141 | 1, 377, 469, 845, 847, 1223, 1315, 1691 |
| 142 | 1, 143, 283, 425, 427, 569, 709, 851, 853, 995, 1135, 1277, |
| | 1279, 1421, 1561, 1703 |
| 143 | 1, 131, 155, 287, 571, 703, 727, 857, 859, 989, 1013, 1145, |
| | 1429, 1561, 1585, 1715 |
| 144 | 1, 161, 703, 863, 865, 1025, 1567, 1727 |
| 145 | 1, 59, 289, 349, 521, 581, 811, 869, 871, 929, 1159, 1219, |
| | 1391, 1451, 1681, 1739 |
| 146 | 1, 145, 293, 437, 439, 583, 731, 875, 877, 1021, 1169, 1313, |
| | 1315, 1459, 1607, 1751 |
| 147 | 1, 197, 685, 881, 883, 1079, 1567, 1763 |
| 148 | 1, 73, 223, 295, 593, 665, 815, 887, 889, 961, 1111, 1183, |
| | 1481, 1553, 1703, 1775 |
| 149 | 1, 299, 595, 893, 895, 1193, 1489, 1787 |
| 150 | 1, 199, 251, 449, 451, 649, 701, 899, 901, 1099, 1151, 1349, |
| | 1351, 1549, 1601, 1799 |
| 151 | 1, 301, 605, 905, 907, 1207, 1511, 1811 |
| 152 | 1, 113, 191, 305, 607, 721, 799, 911, 913, 1025, 1103, 1217, |
| | 1519, 1633, 1711, 1823 |
| 153 | 1, 271, 647, 917, 919, 1189, 1565, 1835 |
| 154 | 1, 43, 155, 197, 265, 307, 419, 461, 463, 505, 617, 659, 727, |
| | 769, 881, 923, 925, 967, 1079, 1121, 1189, 1231, 1343, 1385, |
| | 1387, 1429, 1541, 1583, 1651, 1693, 1805, 1847 |
| 155 | 1, 61, 311, 371, 559, 619, 869, 929, 931, 991, 1241, 1301, |
| | 1489, 1549, 1799, 1859 |
| 156 | 1, 233, 287, 415, 521, 649, 703, 935, 937, 1169, 1223, 1351, |
| | 1457, 1585, 1639, 1871 |
| 157 | 1, 313, 629, 941, 943, 1255, 1571, 1883 |
| 158 | 1, 157, 317, 473, 475, 631, 791, 947, 949, 1105, 1265, 1421, |
| | 1423, 1579, 1739, 1895 |
| 159 | 1, 107, 847, 953, 955, 1061, 1801, 1907 |
| 160 | 1, 191, 319, 449, 511, 641, 769, 959, 961, 1151, 1279, 1409, |
| | 1471, 1601, 1729, 1919 |
| 161 | 1, 139, 323, 461, 505, 643, 827, 965, 967, 1105, 1289, 1427, |
| | 1471, 1609, 1793, 1931 |
| 162 | 1, 485, 487, 971, 973, 1457, 1459, 1943 |
| 163 | 1, 325, 653, 977, 979, 1303, 1631, 1955 |
| 164 | 1, 247, 329, 409, 575, 655, 737, 983, 985, 1231, 1313, 1393, |
| | 1559, 1639, 1721, 1967 |
| 165 | 1, 89, 109, 199, 791, 881, 901, 989, 991, 1079, 1099, 1189, |
| | 1781, 1871, 1891, 1979 |
| 166 | 1, 167, 331, 497, 499, 665, 829, 995, 997, 1163, 1327, 1493, |
| | 1495, 1661, 1825, 1991 |
| 167 | 1, 335, 667, 1001, 1003, 1337, 1669, 2003 |
| 168 | 1, 127, 433, 449, 559, 575, 881, 1007, 1009, 1135, 1441, 1457, |
| | 1567, 1583, 1889, 2015 |
| 169 | 1, 337, 677, 1013, 1015, 1351, 1691, 2027 |
| 170 | 1, 101, 169, 239, 271, 341, 409, 509, 511, 611, 679, 749, 781, |
| | 851, 919, 1019, 1021, 1121, 1189, 1259, 1291, 1361, 1429, |
| | 1529, 1531, 1631, 1699, 1769, 1801, 1871, 1939, 2039 |
| 171 | 1, 379, 647, 1025, 1027, 1405, 1673, 2051 |
| 172 | 1, 257, 343, 431, 601, 689, 775, 1031, 1033, 1289, 1375, 1463, |
| | 1633, 1721, 1807, 2063 |
| 173 | 1, 347, 691, 1037, 1039, 1385, 1729, 2075 |
| 174 | 1, 233, 289, 521, 523, 755, 811, 1043, 1045, 1277, 1333, 1565, |
| | 1567, 1799, 1855, 2087 |
| 175 | 1, 251, 349, 449, 601, 701, 799, 1049, 1051, 1301, 1399, 1499, |
| | 1651, 1751, 1849, 2099 |
| 176 | 1, 65, 287, 353, 703, 769, 991, 1055, 1057, 1121, 1343, 1409, |
| | 1759, 1825, 2047, 2111 |
| 177 | 1, 235, 827, 1061, 1063, 1297, 1889, 2123 |
| 178 | 1, 179, 355, 533, 535, 713, 889, 1067, 1069, 1247, 1423, 1601, |
| | 1603, 1781, 1957, 2135 |
| 179 | 1, 359, 715, 1073, 1075, 1433, 1789, 2147 |
| 180 | 1, 161, 271, 431, 649, 809, 919, 1079, 1081, 1241, 1351, 1511, |
| | 1729, 1889, 1999, 2159 |
| 181 | 1, 361, 725, 1085, 1087, 1447, 1811, 2171 |
| 182 | 1, 155, 181, 209, 337, 365, 391, 545, 547, 701, 727, 755, 883, |
| | 911, 937, 1091, 1093, 1247, 1273, 1301, 1429, 1457, 1483, 1637, |
| | 1639, 1793, 1819, 1847, 1975, 2003, 2029, 2183 |
| 183 | 1, 487, 611, 1097, 1099, 1585, 1709, 2195 |
| 184 | 1, 47, 367, 415, 689, 737, 1057, 1103, 1105, 1151, 1471, 1519, |
| | 1793, 1841, 2161, 2207 |
| 185 | 1, 149, 221, 371, 739, 889, 961, 1109, 1111, 1259, 1331, 1481, |
| | 1849, 1999, 2071, 2219 |
| 186 | 1, 125, 433, 557, 559, 683, 991, 1115, 1117, 1241, 1549, 1673, |
| | 1675, 1799, 2107, 2231 |
| 187 | 1, 67, 307, 373, 749, 815, 1055, 1121, 1123, 1189, 1429, 1495, |
| | 1871, 1937, 2177, 2243 |
| 188 | 1, 95, 281, 377, 751, 847, 1033, 1127, 1129, 1223, 1409, 1505, |
| | 1879, 1975, 2161, 2255 |
| 189 | 1, 323, 811, 1133, 1135, 1457, 1945, 2267 |
| 190 | 1, 151, 191, 229, 341, 379, 419, 569, 571, 721, 761, 799, 911, |
| | 949, 989, 1139, 1141, 1291, 1331, 1369, 1481, 1519, 1559, 1709, |
| | 1711, 1861, 1901, 1939, 2051, 2089, 2129, 2279 |
| 191 | 1, 383, 763, 1145, 1147, 1529, 1909, 2291 |
| 192 | 1, 127, 1025, 1151, 1153, 1279, 2177, 2303 |
| 193 | 1, 385, 773, 1157, 1159, 1543, 1931, 2315 |
| 194 | 1, 193, 389, 581, 583, 775, 971, 1163, 1165, 1357, 1553, 1745, |
| | 1747, 1939, 2135, 2327 |
| 195 | 1, 181, 469, 521, 649, 701, 989, 1169, 1171, 1351, 1639, 1691, |
| | 1819, 1871, 2159, 2339 |
| 196 | 1, 97, 295, 391, 785, 881, 1079, 1175, 1177, 1273, 1471, 1567, |
| | 1961, 2057, 2255, 2351 |
| 197 | 1, 395, 787, 1181, 1183, 1577, 1969, 2363 |
| 198 | 1, 109, 485, 593, 595, 703, 1079, 1187, 1189, 1297, 1673, 1781, |
| | 1783, 1891, 2267, 2375 |
| 199 | 1, 397, 797, 1193, 1195, 1591, 1991, 2387 |
| 200 | 1, 49, 401, 449, 751, 799, 1151, 1199, 1201, 1249, 1601, 1649, |
| | 1951, 1999, 2351, 2399 |
| 201 | 1, 269, 937, 1205, 1207, 1475, 2143, 2411 |
| 202 | 1, 203, 403, 605, 607, 809, 1009, 1211, 1213, 1415, 1615, 1817, |
| | 1819, 2021, 2221, 2423 |
| 203 | 1, 349, 407, 463, 755, 811, 869, 1217, 1219, 1567, 1625, 1681, |
| | 1973, 2029, 2087, 2435 |
| 204 | 1, 271, 305, 577, 647, 919, 953, 1223, 1225, 1495, 1529, 1801, |
| | 1871, 2143, 2177, 2447 |
| 205 | 1, 329, 409, 491, 739, 821, 901, 1229, 1231, 1559, 1639, 1721, |
| | 1969, 2051, 2131, 2459 |
| 206 | 1, 205, 413, 617, 619, 823, 1031, 1235, 1237, 1441, 1649, 1853, |
| | 1855, 2059, 2267, 2471 |
| 207 | 1, 323, 919, 1241, 1243, 1565, 2161, 2483 |
| 208 | 1, 287, 415, 545, 703, 833, 961, 1247, 1249, 1535, 1663, 1793, |
| | 1951, 2081, 2209, 2495 |
| 209 | 1, 265, 419, 571, 683, 835, 989, 1253, 1255, 1519, 1673, 1825, |
| | 1937, 2089, 2243, 2507 |
| 210 | 1, 71, 181, 251, 379, 449, 559, 629, 631, 701, 811, 881, 1009, |
| | 1079, 1189, 1259, 1261, 1331, 1441, 1511, 1639, 1709, 1819, |
| | 1889, 1891, 1961, 2071, 2141, 2269, 2339, 2449, 2519 |
| 211 | 1, 421, 845, 1265, 1267, 1687, 2111, 2531 |
| 212 | 1, 319, 425, 529, 743, 847, 953, 1271, 1273, 1591, 1697, 1801, |
| | 2015, 2119, 2225, 2543 |
| 213 | 1, 143, 1135, 1277, 1279, 1421, 2413, 2555 |
| 214 | 1, 215, 427, 641, 643, 857, 1069, 1283, 1285, 1499, 1711, 1925, |
| | 1927, 2141, 2353, 2567 |
| 215 | 1, 259, 431, 601, 689, 859, 1031, 1289, 1291, 1549, 1721, 1891, |
| | 1979, 2149, 2321, 2579 |
| 216 | 1, 161, 1135, 1295, 1297, 1457, 2431, 2591 |
| 217 | 1, 125, 433, 559, 743, 869, 1177, 1301, 1303, 1427, 1735, 1861, |
| | 2045, 2171, 2479, 2603 |
| 218 | 1, 217, 437, 653, 655, 871, 1091, 1307, 1309, 1525, 1745, 1961, |
| | 1963, 2179, 2399, 2615 |
| 219 | 1, 145, 1169, 1313, 1315, 1459, 2483, 2627 |
| 220 | 1, 89, 199, 241, 329, 439, 529, 551, 769, 791, 881, 991, 1079, |
| | 1121, 1231, 1319, 1321, 1409, 1519, 1561, 1649, 1759, 1849, |
| | 1871, 2089, 2111, 2201, 2311, 2399, 2441, 2551, 2639 |
| 221 | 1, 103, 443, 545, 781, 883, 1223, 1325, 1327, 1429, 1769, |
| | 1871, 2107, 2209, 2549, 2651 |
| 222 | 1, 73, 593, 665, 667, 739, 1259, 1331, 1333, 1405, 1925, |
| | 1997, 1999, 2071, 2591, 2663 |
| 223 | 1, 445, 893, 1337, 1339, 1783, 2231, 2675 |
| 224 | 1, 127, 449, 575, 769, 895, 1217, 1343, 1345, 1471, 1793, |
| | 1919, 2113, 2239, 2561, 2687 |
| 225 | 1, 649, 701, 1349, 1351, 1999, 2051, 2699 |
| 226 | 1, 227, 451, 677, 679, 905, 1129, 1355, 1357, 1583, 1807, |
| | 2033, 2035, 2261, 2485, 2711 |
| 227 | 1, 455, 907, 1361, 1363, 1817, 2269, 2723 |
| 228 | 1, 305, 343, 647, 721, 1025, 1063, 1367, 1369, 1673, 1711, |
| | 2015, 2089, 2393, 2431, 2735 |
| 229 | 1, 457, 917, 1373, 1375, 1831, 2291, 2747 |
| 230 | 1, 91, 139, 229, 461, 551, 599, 689, 691, 781, 829, 919, |
| | 1151, 1241, 1289, 1379, 1381, 1471, 1519, 1609, 1841, 1931, |
| | 1979, 2069, 2071, 2161, 2209, 2299, 2531, 2621, 2669, 2759 |
| 231 | 1, 197, 307, 505, 881, 1079, 1189, 1385, 1387, 1583, 1693, |
| | 1891, 2267, 2465, 2575, 2771 |
| 232 | 1, 175, 289, 463, 929, 1103, 1217, 1391, 1393, 1567, 1681, |
| | 1855, 2321, 2495, 2609, 2783 |
| 233 | 1, 467, 931, 1397, 1399, 1865, 2329, 2795 |
| 234 | 1, 53, 649, 701, 703, 755, 1351, 1403, 1405, 1457, 2053, |
| | 2105, 2107, 2159, 2755, 2807 |
| 235 | 1, 281, 469, 659, 751, 941, 1129, 1409, 1411, 1691, 1879, |
| | 2069, 2161, 2351, 2539, 2819 |
| 236 | 1, 119, 353, 473, 943, 1063, 1297, 1415, 1417, 1535, 1769, |
| | 1889, 2359, 2479, 2713, 2831 |
| 237 | 1, 631, 791, 1421, 1423, 2053, 2213, 2843 |
| 238 | 1, 169, 239, 307, 407, 475, 545, 713, 715, 883, 953, 1021, |
| | 1121, 1189, 1259, 1427, 1429, 1597, 1667, 1735, 1835, 1903, |
| | 1973, 2141, 2143, 2311, 2381, 2449, 2549, 2617, 2687, 2855 |
| 239 | 1, 479, 955, 1433, 1435, 1913, 2389, 2867 |
| 240 | 1, 161, 289, 449, 991, 1151, 1279, 1439, 1441, 1601, 1729, |
| | 1889, 2431, 2591, 2719, 2879 |
| 241 | 1, 481, 965, 1445, 1447, 1927, 2411, 2891 |
| 242 | 1, 241, 485, 725, 727, 967, 1211, 1451, 1453, 1693, 1937, |
| | 2177, 2179, 2419, 2663, 2903 |
| 243 | 1, 1457, 1459, 2915 |
| 244 | 1, 121, 367, 487, 977, 1097, 1343, 1463, 1465, 1585, 1831, |
| | 1951, 2441, 2561, 2807, 2927 |
| 245 | 1, 391, 491, 589, 881, 979, 1079, 1469, 1471, 1861, 1961, |
| | 2059, 2351, 2449, 2549, 2939 |
| 246 | 1, 163, 575, 737, 739, 901, 1313, 1475, 1477, 1639, 2051, |
| | 2213, 2215, 2377, 2789, 2951 |
| 247 | 1, 77, 493, 571, 911, 989, 1405, 1481, 1483, 1559, 1975, |
| | 2053, 2393, 2471, 2887, 2963 |
| 248 | 1, 433, 497, 559, 929, 991, 1055, 1487, 1489, 1921, 1985, |
| | 2047, 2417, 2479, 2543, 2975 |
| 249 | 1, 665, 829, 1493, 1495, 2159, 2323, 2987 |
| 250 | 1, 251, 499, 749, 751, 1001, 1249, 1499, 1501, 1751, 1999, |
| | 2249, 2251, 2501, 2749, 2999 |
| 251 | 1, 503, 1003, 1505, 1507, 2009, 2509, 3011 |
| 252 | 1, 55, 377, 433, 1079, 1135, 1457, 1511, 1513, 1567, 1889, |
| | 1945, 2591, 2647, 2969, 3023 |
| 253 | 1, 461, 505, 551, 967, 1013, 1057, 1517, 1519, 1979, 2023, |
| | 2069, 2485, 2531, 2575, 3035 |
| 254 | 1, 253, 509, 761, 763, 1015, 1271, 1523, 1525, 1777, 2033, |
| | 2285, 2287, 2539, 2795, 3047 |
| 255 | 1, 271, 341, 611, 919, 1189, 1259, 1529, 1531, 1801, 1871, |
| | 2141, 2449, 2719, 2789, 3059 |
| 256 | 1, 511, 1025, 1535, 1537, 2047, 2561, 3071 |
| 257 | 1, 515, 1027, 1541, 1543, 2057, 2569, 3083 |
| 258 | 1, 343, 431, 773, 775, 1117, 1205, 1547, 1549, 1891, 1979, |
| | 2321, 2323, 2665, 2753, 3095 |
| 259 | 1, 223, 295, 517, 1037, 1259, 1331, 1553, 1555, 1777, 1849, |
| | 2071, 2591, 2813, 2885, 3107 |
| 260 | 1, 79, 209, 311, 391, 521, 599, 649, 911, 961, 1039, 1169, |
| | 1249, 1351, 1481, 1559, 1561, 1639, 1769, 1871, 1951, 2081, |
| | 2159, 2209, 2471, 2521, 2599, 2729, 2809, 2911, 3041, 3119 |
| 261 | 1, 755, 811, 1565, 1567, 2321, 2377, 3131 |
| 262 | 1, 263, 523, 785, 787, 1049, 1309, 1571, 1573, 1835, 2095, |
| | 2357, 2359, 2621, 2881, 3143 |
| 263 | 1, 527, 1051, 1577, 1579, 2105, 2629, 3155 |
| 264 | 1, 287, 593, 703, 881, 991, 1297, 1583, 1585, 1871, 2177, |
| | 2287, 2465, 2575, 2881, 3167 |
| 265 | 1, 211, 319, 529, 1061, 1271, 1379, 1589, 1591, 1801, 1909, |
| | 2119, 2651, 2861, 2969, 3179 |
| 266 | 1, 113, 265, 379, 419, 533, 685, 797, 799, 911, 1063, 1177, |
| | 1217, 1331, 1483, 1595, 1597, 1709, 1861, 1975, 2015, 2129, |
| | 2281, 2393, 2395, 2507, 2659, 2773, 2813, 2927, 3079, 3191 |
| 267 | 1, 179, 1423, 1601, 1603, 1781, 3025, 3203 |
| 268 | 1, 401, 535, 671, 937, 1073, 1207, 1607, 1609, 2009, 2143, |
| | 2279, 2545, 2681, 2815, 3215 |
| 269 | 1, 539, 1075, 1613, 1615, 2153, 2689, 3227 |
| 270 | 1, 161, 649, 809, 811, 971, 1459, 1619, 1621, 1781, 2269, |
| | 2429, 2431, 2591, 3079, 3239 |
| 271 | 1, 541, 1085, 1625, 1627, 2167, 2711, 3251 |
| 272 | 1, 511, 545, 577, 1055, 1087, 1121, 1631, 1633, 2143, 2177, |
| | 2209, 2687, 2719, 2753, 3263 |
| 273 | 1, 181, 701, 755, 883, 937, 1457, 1637, 1639, 1819, 2339, |
| | 2393, 2521, 2575, 3095, 3275 |
| 274 | 1, 275, 547, 821, 823, 1097, 1369, 1643, 1645, 1919, 2191, |
| | 2465, 2467, 2741, 3013, 3287 |
| 275 | 1, 199, 551, 749, 901, 1099, 1451, 1649, 1651, 1849, 2201, |
| | 2399, 2551, 2749, 3101, 3299 |

For these embodiments to function, parameters are configured at both the transmitter and the receiver. Some of these parameters may be specified and some of these parameters may signaled between the transmitter and the receiver. The expression of phase rotated permutation matrix may be specified for a given c and M. In some embodiments, the parameter c values may be specified at the transmitter and the receiver for different values of M. This may be as given in Table 2. Alternatively, in some embodiments, only a fixed set of parameters c may be specified, (e.g., only two or four values may be specified for a given M). In this case, a subset of the values shown in Table 2 may be chosen. If there are only two choices, then one bit can be used to distinguish two values. As an example, bit 0 may be used to identify the first value of c and bit 1 may be used for a second value of c for a given M. In this example, the bit mapping operation may be denoted by b(c, M). Table 3 gives an example of this bit mapping for M=12 for all possible two values of c.

TABLE 3
Parameter c represented by 1 bit for M = 12

| Bit | Op- | Op- | Op- | Op- | Op- | Op- |
|---|---|---|---|---|---|---|
| sequence | tion 1 | tion 2 | tion 3 | tion 4 | tion 5 | tion 6 |
| b(c, M) | for c | for c | for c | for c | for c | for c |
| 0 | 1 | 1 | 1 | 5 | 5 | 7 |
| 1 | 5 | 7 | 11 | 7 | 11 | 11 |

If four values for parameter c are specified for each M, then two bits are required to identify four values. For example, the two bit pattern 0 0 may be used to identify the first value of c, the two bit pattern 0 1 may be used to identify the second value of c, the two bit pattern 1 0 may be used to identify the third value of c, and the two bit pattern 1 1 may be used to identify the last value of c. In this example, the bit mapping operation may be denoted as b(c, M). Table 4 gives an example of this bit mapping for M=12.

TABLE 4
Parameter c represented by 2 bits for M = 12

| Bit sequence b(c, M) | Parameter c (M = 12) |
|---|---|
| 00 | 1 |
| 01 | 5 |
| 10 | 7 |
| 11 | 11 |

Once bit mapping and a table of parameter c are specified, the bit sequence b(c, M) can be shared between the transmitter and the receiver through signaling. Then the transmitter and the receiver can obtain the corresponding c value for a respective M. A new field may be created for the bit sequence b(c, M), and in the case of 3GPP specifications, this field can be contained in downlink control information (DCI)/uplink control information (UCI) or other signaling methods such as radio resource control (RRC), or a MAC-CE (Control Element). Then both the transmitter and receiver can use the parameter c to obtain the phase rotated permutation and de-permutation matrices.

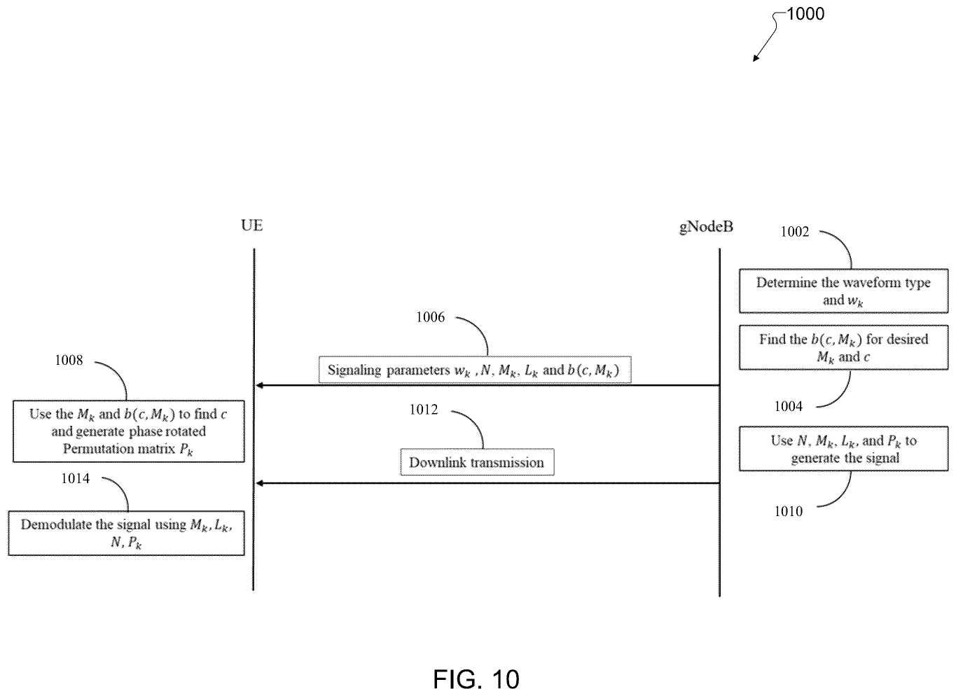

FIG. 10 illustrates an example procedure 1000 for downlink signaling according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for downlink signaling could be used without departing from the scope of this disclosure.

In the example of FIG. 10, a gNB (such as BS 102 of FIG. 1) is operating as a transmitter in the downlink, and a UE (such as UE 116 of FIG. 1) is operating as a receiver.

Procedure 1000 begins at operation 1002. At operation 1002, the gNB determines the waveform for the respective UE. The determination may be performed similar as described above herein. The wₖ parameter (e.g., from Table 1) is set based on the selected waveform type.

If the selected waveform type is the DFT-p-OFDM waveform, at operation 1004, the gNB selects the desired c parameter and allocated subcarriers Mₖ, (such as in Table 2) which are used to find the bit mapping function b(c, Mₖ) (such as in Table 3, or Table 4).

At operation 1006, the gNB transmits the signaling parameters including wₖ, N, Lₖ, c, Mₖ and b(c, Mₖ) to the respective UE.

At operation 1008, the UE uses the signaling parameters Mₖ and b(c, Mₖ) to find the corresponding c parameter and use the c parameter to generate the phase rotated permutation matrix Pₖ.

At operation 1010, the gNB generates a data signal using the selected waveform type according to the signaling parameters transmitted to the UE at step 1006.

At operation 1012, the gNB transmits the data signal as a downlink transmission.

At operation 1014, the UE demodulates the received signal by using the signaling parameters received from the gNB at step 1006.

Although FIG. 10 illustrates one example procedure 1000 for downlink signaling, various changes may be made to FIG. 10. For example, while shown as a series of operations, various operations in FIG. 10 could overlap, occur in parallel, occur in a different order, occur any number of times, be omitted, or replaced by other operations.

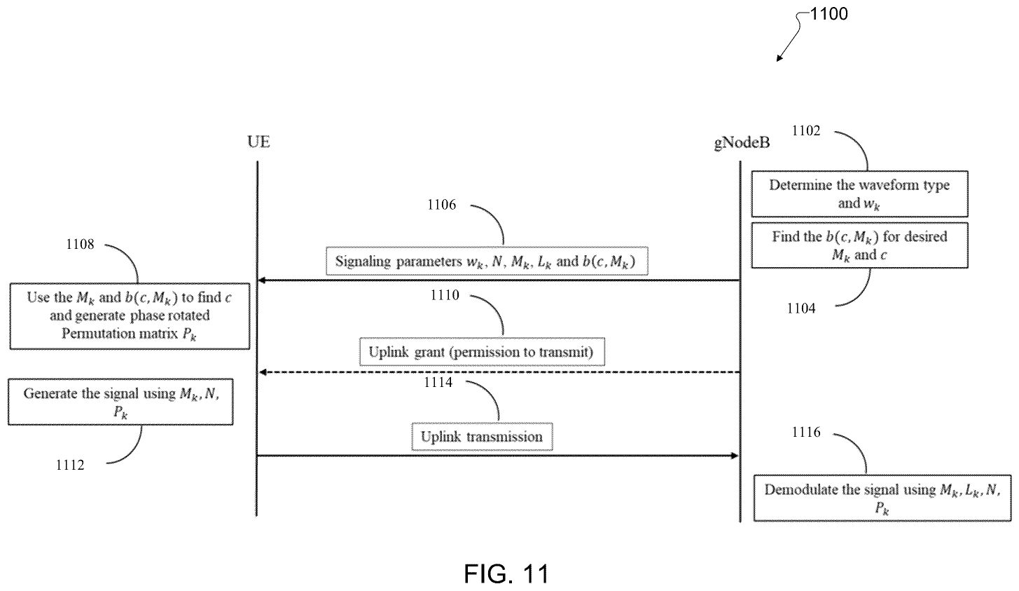

FIG. 11 illustrates an example procedure 1100 for uplink signaling according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for uplink signaling could be used without departing from the scope of this disclosure.

In the example of FIG. 11, a gNB (such as BS 102 of FIG. 1) is operating as a receiver in the uplink, and a UE (such as UE 116 of FIG. 1) is operating as a transmitter.

Procedure 1100 begins at operation 1102. At operation 1102, the gNB determines the waveform type for the respective UE. This may be performed as described herein. The wₖ parameter is set based on the selected waveform type.

At operation 1104, if the selected waveform type is the DFT-p-OFDM waveform, the gNB selects the desired c parameter and allocated subcarriers Mₖ, which are used to find the bit mapping function b(c, Mₖ).

At operation 1106, the gNB transmits the signaling parameters wₖ, N, Lₖ, C, Mₖ and b(c, Mₖ) to the respective UE.

At operation 1108, the UE uses Mₖ and b(c, Mₖ) to find the corresponding c parameter and uses it to generate the phase rotated permutation matrix Pₖ.

At operation 1110, the gNB indicates to UE the permission to transmit. In some embodiments, operation 1110 may be optional.

At operation 1112, the UE generates the data signal using the selected waveform type. At operation 1114, the UE performs the uplink transmission.

At operation 1116, the gNB demodulates the received signal by using the waveform parameters.

Although FIG. 11 illustrates one example method for procedure 1100 for uplink signaling, various changes may be made to FIG. 11. For example, while shown as a series of steps, various steps in FIG. 11 could overlap, occur in parallel, occur in a different order, occur any number of times, be omitted, or replaced by other steps.

In some embodiments, the phase rotated permutation matrix can be obtained by fixing the parameter as follows for even values of M

$$c = \frac{M}{2} + 1 ,$$

$$Or$$

$$c = \frac{M}{2} - 1$$

Then the parameter c can be used to find the m^{th} row (m∈{0, 1, . . . , M−1}) and l^{th} column (l∈{0, 1, . . . , M−1}) of phase rotated permutation matrix P by

$${P}_{m l} = \frac{1}{M \sqrt{M}} {\sum }_{k = 0}^{M - 1} {\sum }_{n = 0}^{M - 1} exp ( j 2 π ( \frac{- 2 km + c {k}^{2} + 2 nk + c {n}^{2} + 2 nl}{2 M} ) )$$

In the matrix form, P can be obtained by:

$$P = {F}_{M} {Λ}_{c}^{H} {F}_{M}^{H} {Λ}_{c}^{H} {F}_{M}^{H}$$

where the F_{M} denotes the M×M Fourier transform matrix and

$${F}_{M}^{H}$$

is the M×M inverse Fourier transform matrix. Further

$${Λ}_{c}^{H}$$

is the Hermitian or Λ_{c}, and Λ_{c} is a diagonal matrix such that the m^{th} diagonal element is given by the e^{-i2πcm}^{²}^{/2M} where m∈{1, 2, . . . , M} and

$$c = \frac{M}{2} + 1 or c = \frac{M}{2} - 1.$$

For theses embodiments to function, parameters are configured at both the transmitter and the receiver. In some embodiments, some of these parameters may be specified and some parameters are signaled between the transmitter and the receiver. In this case, at least two options are possible.

Option 1: either

$$c = \frac{M}{2} + 1 or c = \frac{M}{2} - 1$$

is specified at the transmitter and the receiver such that for a given M, both the transmitter and the receiver know the parameter c.

Option 2: both

$$c = \frac{M}{2} + 1 and c = \frac{M}{2} - 1$$

are specified at the transmitter and the receiver such that for a given M, both the transmitter and the receiver can find

$$c = \frac{M}{2} + 1 and c = \frac{M}{2} - 1.$$

In this option, an additional signaling parameter is used to pick either

$$c = \frac{M}{2} + 1 or c = \frac{M}{2} - 1$$

such that both the transmitter and the receiver agree to use the same parameter. This can be done by adding a new bit to the existing signaling signal where the bit value 0 selects

$$c = \frac{M}{2} + 1$$

and the bit value 1 selects

$$c = \frac{M}{2} - 1 .$$

This is denoted by b(c). For example, in 3GPP specifications, the bit b(c) can be contained in downlink control information (DCI)/uplink control information (UCI) or other signaling methods such as radio resource control (RRC), MAC-CE (Control Element).

TABLE 5
Bit mapping function b(c)

| Bit sequence b(c) | Parameter c |
|---|---|
| 0 | $\frac{M}{2} + 1$ |
| 1 | $\frac{M}{2} - 1$ |

Further, the procedure to obtain the phase rotated permutation matrix is also specified as given above such that for a given c and M, both the transmitter and the receiver can obtain the phase rotated permutation matrix P.

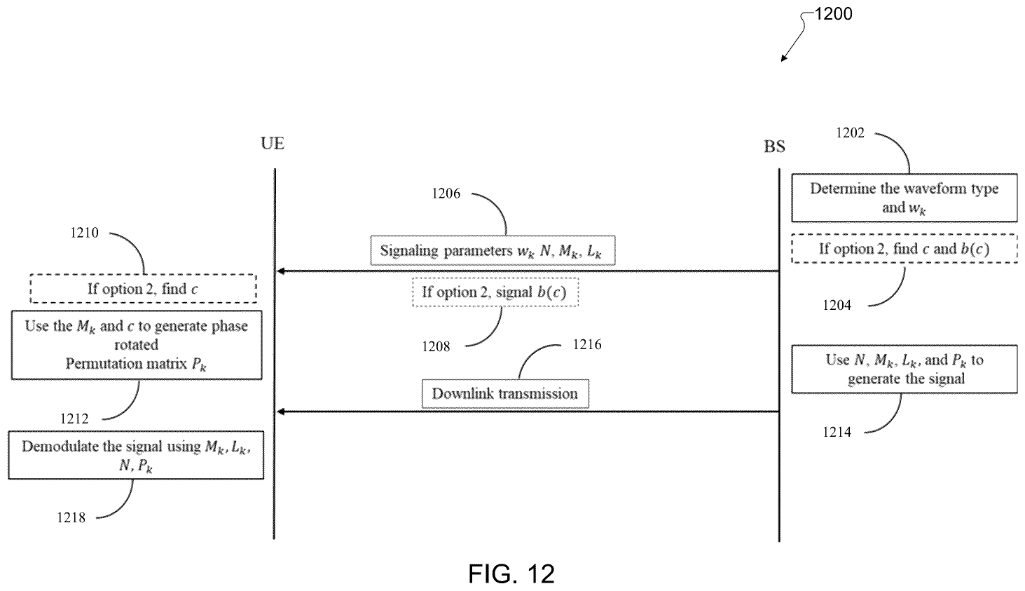

FIG. 12 illustrates another example procedure 1200 for downlink signaling according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments for downlink signaling could be used without departing from the scope of this disclosure.

In the example of FIG. 12 a gNB (such as BS 102 of FIG. 1) is operating as a transmitter in the downlink, and a UE (such as UE 116 of FIG. 1) is operating as a receiver, and parameters are configured at both the transmitter and the receiver. In some embodiments, some of these parameters may be specified and some parameters are signaled between transmitter and the receiver. In this case, at least two options are possible:

Option 1: either

$$c = \frac{M}{2} + 1 or c = \frac{M}{2} - 1$$

is specified at the transmitter and the receiver such that for a given M, both the transmitter and the receiver know the parameter c.

Option 2: both

$$c = \frac{M}{2} + 1 and c = \frac{M}{2} - 1$$

are specified at the transmitter and the receiver such that for a given M, both the transmitter and the receiver can find

$$c = \frac{M}{2} + 1 and c = \frac{M}{2} - 1.$$

In this option, an additional signaling parameter is used to pick either

$$c = \frac{M}{2} + 1 or c = \frac{M}{2} - 1$$

such that both the transmitter and the receiver agree to use the same parameter, as described above herein.

Procedure 1200 begins at operation 1202. At operation 1202, the gNB determines the waveform for the respective UE. This may be performed as described herein. The wₖ parameter is set based on the selected waveform type.

If option 2 is specified, at operation 1204, the gNB selects the desired c parameter and finds the bit mapping function b(c). Operation 1204 is not available for option 1 in the embodiment of FIG. 12.

At operation 1206, the gNB transmits the signaling parameters wₖ, N, Lₖ, Mₖ.

If option 2 is specified, at operation 1208, the bit mapping b(c) is signaled and this operation may happen simultaneously with operation 1206. Operation 1208 is not available for option 1 in the embodiment of FIG. 12.

If option 2 is specified, at operation 1210, the UE finds the parameter c from b(c). Operation 1210 is not available for option 1 in the embodiment of FIG. 12.

At operation 1212, the UE uses Mₖ and c to generate the phase rotated permutation matrix Pₖ.

At operation 1214, the gNB generates the data signal using the selected waveform type.

At operation 1216, the gNB transmits the data signal as the downlink transmission.

At operation 1218, the UE demodulates the received signal by using the waveform parameters.

Although FIG. 12 illustrates one example procedure 1200 for downlink signaling, various changes may be made to FIG. 12. For example, while shown as a series of operations, various operations in FIG. 12 could overlap, occur in parallel, occur in a different order, occur any number of times, be omitted, or replaced by other operations.

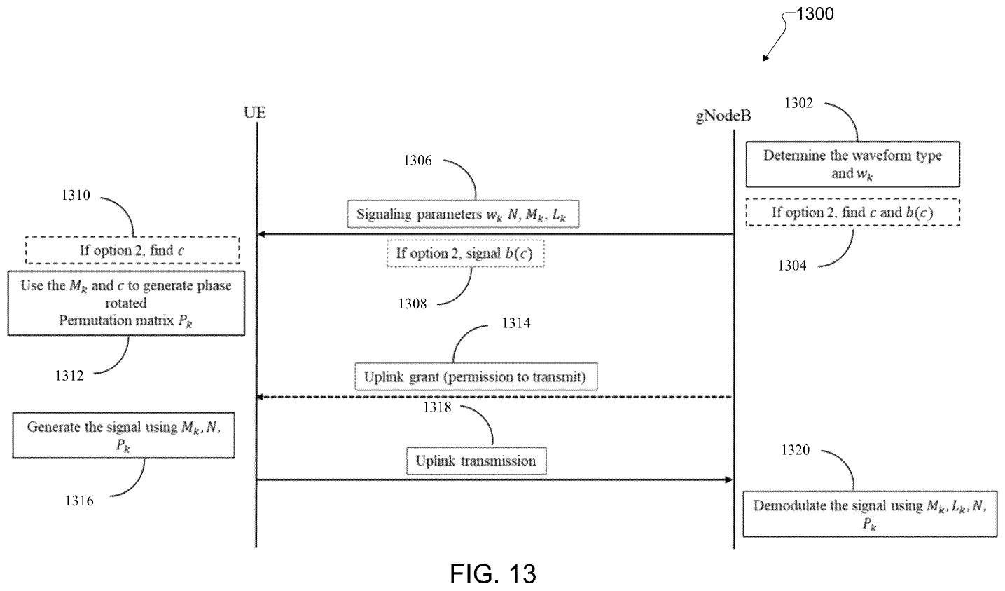

FIG. 13 illustrates another example procedure 1300 for uplink signaling according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for uplink signaling could be used without departing from the scope of this disclosure.

In the example of FIG. 11, a gNB (such as BS 102 of FIG. 1) is operating as a receiver in the uplink, and a UE (such as UE 116 of FIG. 1) is operating as a transmitter, and parameters are configured at both the transmitter and the receiver. In some embodiments, some of these parameters may be specified and some parameters are signaled between the transmitter and the receiver. In this case, at least two options are possible:

Option 1: either

$$c = \frac{M}{2} + 1 or c = \frac{M}{2} - 1$$

is specified at the transmitter and the receiver such that for a given M, both the transmitter and the receiver know the parameter c.

Option 2: both

$$c = \frac{M}{2} + 1 and c = \frac{M}{2} - 1$$

are specified at the transmitter and the receiver such that for a given M, both the transmitter and the receiver can find

$$c = \frac{M}{2} + 1 and c = \frac{M}{2} - 1.$$

In this option, an additional signaling parameter is used to pick either

$$c = \frac{M}{2} + 1 or c = \frac{M}{2} - 1$$

such that both the transmitter and the receiver agree to use the same parameter, as described above herein.

Procedure 1300 begins at operation 1302. At operation 1302, the gNB determines the waveform type for the respective UE. This may be performed as described herein. The wₖ parameter is set based on the selected waveform type.

If option 2 is specified, at operation 1304, the gNB selects the desired c parameter and find the bit mapping function b(c). Operation 1304 is not available for option 1 in the embodiment of FIG. 13.

At operation 1306, the gNB transmits the signaling parameters wₖ, N, Lₖ, Mₖ.

If option 2 is specified, at operation 1308, the bit mapping b(c) is signaled and this operation may happen simultaneously with operation 1306. Operation 1308 is not available for option 1 in the embodiment of FIG. 13.

If option 2 is specified, at operation 1310, the UE finds the parameter c from b(c). Operation 1310 is not available for option 1 in the embodiment of FIG. 13.

At operation 1312, the UE uses Mₖ and c to generate the phase rotated permutation matrix Pₖ.

At operation 1314, the gNB indicates to the UE the permission to transmit. In some embodiments, operation 1314 may be optional.

At operation 1316, the UE generates the data signal using the selected waveform type.

At operation 1318, the UE performs the uplink transmission.

At operation 1320, the gNB demodulates the received signal by using the waveform parameters.

Although FIG. 13 illustrates one example method for procedure 1300 for uplink signaling, various changes may be made to FIG. 11. For example, while shown as a series of steps, various steps in FIG. 13 could overlap, occur in parallel, occur in a different order, occur any number of times, be omitted, or replaced by other steps.

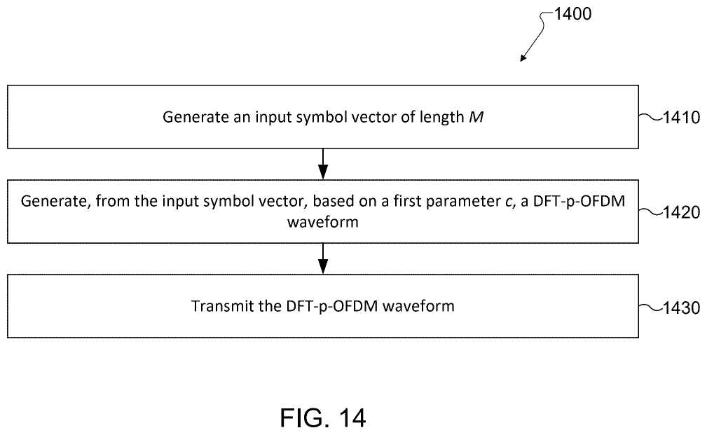

FIG. 14 illustrates an example method for DFT phase rotated permutation based OFDM 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for DFT phase rotated permutation based OFDM could be used without departing from the scope of this disclosure.

In the example of FIG. 14, method 1400 begins at step 1410. At step 1410, an electronic device (such as UE 116 or BS 102 of FIG. 1) generates an input symbol vector of length M.

At step 1420, the electronic device generates, from the input symbol vector, based on a first parameter c, a DFT-p-OFDM waveform.

In some embodiments, to generate the DFT-p-OFDM waveform, the electronic device transforms the input symbol vector into a frequency domain using an M dimensional DFT, rotates the phase of the transformed symbol vector according to the first parameter c, and permutes the phase-rotated symbol vector according to the first parameter c using a unitary phase rotation permutation matrix P. In some embodiments, the electronic device further process the permuted and phase-rotated symbol vector. In some embodiments, to further process the permuted and phase-rotated symbol vector, the electronic device maps the phase rotated and permuted symbol vector to N subcarriers, to generate a mapped signal, wherein N≥M; transforms the mapped signal into a time domain signal using an N sized IDFT; and adds a cyclic prefix (CP) to the time domain signal to generate the DFT-p-OFDM waveform.

In some embodiments, the unitary phase rotation permutation matrix P is generated such that P·PH=I, where PH is a Hermitian transpose of P, and I is an identity matrix.

In some embodiments, each element of the phase rotated and permuted symbol vector is mapped to a unique subcarrier index in a contiguous manner.

In some embodiments, to generate the DFT-p-OFDM waveform, the electronic device separates the input symbol vector into K streams, wherein each of the K streams corresponds to a different UE, transforms a subset K₁ of the K of the streams into a frequency domain using an M dimensional DFT, rotates the phase of each of the transformed streams according to the first parameter c, and permutes each of the phase-rotated streams according to the first parameter c using a unitary phase rotation permutation matrix. In these embodiments, the electronic device also maps the phase rotated and permuted streams and a remainder K₂ of the K streams which are not part of the subset K₁ to N subcarriers to generate a mapped signal, wherein N≥M; transforms the mapped signal into a time domain signal using an N sized IDFT, and adds a CP to the time domain signal to generate the DFT-p-OFDM waveform.

At step 1430, the electronic device transmits the DFT-p-OFDM waveform.

In some embodiments, the electronic device is a UE, and the UE receives, from a BS, waveform parameters for demodulating a second DFT-p-OFDM waveform, generates, based on the waveform parameters and a second parameter c, a phase rotated permutation matrix, receives, from the BS, the second DFT-p-OFDM waveform, and demodulates the second DFT-p-OFDM waveform based on the phase rotated permutation matrix.

In some embodiments, the electronic device is a UE, and the UE receives, from a BS, waveform parameters generating the DFT-p-OFDM waveform, generates, based on the waveform parameters and the first parameter c, a phase rotated permutation matrix, and generates the DFT-p-OFDM waveform based on the phase rotated permutation matrix.

Although FIG. 14 illustrates one example method for DFT phase rotated permutation based OFDM 1400, various changes may be made to FIG. 14. For example, while shown as a series of steps, various steps in FIG. 14 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An electronic device comprising:
a processor configured to:
generate an input symbol vector of length M; and
generate, from the input symbol vector, based on a first parameter c, a discrete Fourier transform-phase rotated permutation-orthogonal frequency division multiplexing (DFT-p-OFDM) waveform; and
a transceiver operably coupled to the processor, the transceiver configured to transmit the DFT-p-OFDM waveform.

2. The electronic device of claim 1, wherein to generate the DFT-p-OFDM waveform, the processor is further configured to:
transform the input symbol vector into a frequency domain using an M dimensional discrete Fourier transform (DFT);
rotate the phase of the transformed symbol vector according to the first parameter c;
permute the phase-rotated symbol vector according to the first parameter c using a unitary phase rotation permutation matrix P; and
further process the permuted and phase-rotated symbol vector.

3. The electronic device of claim 2, wherein to further process the permuted and phase-rotated symbol vector, the processor is further configured to:
map the phase rotated and permuted symbol vector to N subcarriers, to generate a mapped signal, wherein N≥M;
transform the mapped signal into a time domain signal using an N sized inverse DFT (IDFT); and
add a cyclic prefix (CP) to the time domain signal to generate the DFT-p-OFDM waveform.

4. The electronic device of claim 2, wherein the unitary phase rotation permutation matrix P is generated such that P·PH=I, where PH is a Hermitian transpose of P, and I is an identity matrix.

5. The electronic device of claim 2, wherein each element of the phase rotated and permuted symbol vector is mapped to a unique subcarrier index in a contiguous manner.

6. The electronic device of claim 1, wherein to generate the DFT-p-OFDM waveform, the processor is further configured to:
separate the input symbol vector into K streams, wherein each of the K streams corresponds to a different user equipment (UE);
transform a subset K₁ of the K of the streams into a frequency domain using an M dimensional discrete Fourier transform (DFT);
rotate the phase of each of the transformed streams according to the first parameter c;
permute each of the phase-rotated streams according to the first parameter c using a unitary phase rotation permutation matrix;
map the phase rotated and permuted streams and a remainder K₂ of the K streams which are not part of the subset K₁ to N subcarriers to generate a mapped signal, wherein N≥M;
transform the mapped signal into a time domain signal using an N sized inverse DFT (IDFT); and
add a cyclic prefix (CP) to the time domain signal to generate the DFT-p-OFDM waveform.

7. The electronic device of claim 1, wherein:
the electronic device is a user equipment (UE);
the transceiver is further configured to receive, from a base station (BS), waveform parameters for demodulating a second DFT-p-OFDM waveform;
the processor is further configured to generate, based on the waveform parameters and a second parameter c, a phase rotated permutation matrix; and
the transceiver is further configured to:
receive, from the BS, the second DFT-p-OFDM waveform; and
demodulate the second DFT-p-OFDM waveform based on the phase rotated permutation matrix.

8. The electronic device of claim 1, wherein:
the electronic device is a user equipment (UE);
the transceiver is further configured to receive, from a base station (BS), waveform parameters for generating the DFT-p-OFDM waveform; and
the processor is further configured to:
generate, based on the waveform parameters and the first parameter c, a phase rotated permutation matrix; and
generate the DFT-p-OFDM waveform based on the phase rotated permutation matrix.

9. A method of operating an electronic device, the method comprising:
generating an input symbol vector of length M;
generating, from the input symbol vector, based on a first parameter c, a discrete Fourier transform-phase rotated permutation-orthogonal frequency division multiplexing (DFT-p-OFDM) waveform; and
transmitting the DFT-p-OFDM waveform.

10. The method of claim 9, wherein to generate the DFT-p-OFDM waveform, the method further comprises:
transforming the input symbol vector into a frequency domain using an M dimensional discrete Fourier transform (DFT);
rotating the phase of the transformed symbol vector according to the first parameter c;
permuting the phase-rotated symbol vector according to the first parameter c using a unitary phase rotation permutation matrix P; and
further processing the permuted and phase-rotated symbol vector.

11. The method of claim 10, wherein to further process the permuted and phase-rotated symbol vector, the method further comprises:
mapping the phase rotated and permuted symbol vector to N subcarriers, to generate a mapped signal, wherein N≥M;
transforming the mapped signal into a time domain signal using an N sized inverse DFT (IDFT); and
adding a cyclic prefix (CP) to the time domain signal to generate the DFT-p-OFDM waveform.

12. The method of claim 10, wherein the unitary phase rotation permutation matrix P is generated such that P·PH=I, where PH is a Hermitian transpose of P, and I is an identity matrix.

13. The method of claim 10, wherein each element of the phase rotated and permuted symbol vector is mapped to a unique subcarrier index in a contiguous manner.

14. The method of claim 9, wherein to generate the DFT-p-OFDM waveform, the method further comprises:
separating the input symbol vector into K streams, wherein each of the K streams corresponds to a different user equipment (UE);
transforming a subset K₁ of the K of the streams into a frequency domain using an M dimensional discrete Fourier transform (DFT);
rotating the phase of each of the transformed streams according to the first parameter c;
permuting each of the phase-rotated streams according to the first parameter c using a unitary phase rotation permutation matrix;
mapping the phase rotated and permuted streams and a remainder K₂ of the K streams which are not part of the subset K₁ to N subcarriers to generate a mapped signal, wherein N≥M;
transforming the mapped signal into a time domain signal using an N sized inverse DFT (IDFT); and
adding a cyclic prefix (CP) to the time domain signal to generate the DFT-p-OFDM waveform.

15. The method of claim 9, wherein:
the electronic device is a user equipment (UE); and
the method further comprises:
receiving, from a base station (BS), waveform parameters for demodulating a second DFT-p-OFDM waveform;
generating, based on the waveform parameters and a second parameter c, a phase rotated permutation matrix;
receiving, from the BS, the second DFT-p-OFDM waveform; and
demodulating the second DFT-p-OFDM waveform based on the phase rotated permutation matrix.

16. The method of claim 9, wherein:
the electronic device is a user equipment (UE);
the method further comprises:
receive, from a base station (BS), waveform parameters for generating the DFT-p-OFDM waveform;
generating, based on the waveform parameters and the first parameter c, a phase rotated permutation matrix; and
generating the DFT-p-OFDM waveform based on the phase rotated permutation matrix.

17. A non-transitory computer readable medium embodying a computer program, the computer program comprising program code that, when executed by a processor of a device, causes the device to:
generate an input symbol vector of length M;
generate, from the input symbol vector, based on a first parameter c, a discrete Fourier transform-phase rotated permutation-orthogonal frequency division multiplexing (DFT-p-OFDM) waveform; and
transmit the DFT-p-OFDM waveform.

18. The non-transitory computer readable medium of claim 17, wherein to generate the DFT-p-OFDM waveform, the computer program further comprises program code that, when executed by the processor, causes the device to:
transform the input symbol vector into a frequency domain using an M dimensional discrete Fourier transform (DFT);
rotate the phase of the transformed symbol vector according to the first parameter c;
permute the phase-rotated symbol vector according to the first parameter c using a unitary phase rotation permutation matrix P; and
further process the permuted and phase-rotated symbol vector.

19. The non-transitory computer readable medium of claim 18, wherein to further process the permuted and phase-rotated symbol vector, the computer program further comprises program code that, when executed by the processor, causes the device to:
map the phase rotated and permuted symbol vector to N subcarriers, to generate a mapped signal, wherein N≥M;
transform the mapped signal into a time domain signal using an N sized inverse DFT (IDFT); and
add a cyclic prefix (CP) to the time domain signal to generate the DFT-p-OFDM waveform.

20. The non-transitory computer readable medium of claim 17, wherein to generate the DFT-p-OFDM waveform, the computer program further comprises program code that, when executed by the processor, causes the device to:
separate the input symbol vector into K streams, wherein each of the K streams corresponds to a different user equipment (UE);
transform a subset K₁ of the K of the streams into a frequency domain using an M dimensional discrete Fourier transform (DFT);
rotate the phase of each of the transformed streams according to the first parameter c;
permute each of the phase-rotated streams according to the first parameter c using a unitary phase rotation permutation matrix;
map the phase rotated and permuted streams and a K₂ remainder of the K streams which are not part of the subset K₁ to N subcarriers to generate a mapped signal, wherein N≥M;
transform the mapped signal into a time domain signal using an N sized inverse DFT (IDFT); and
add a cyclic prefix (CP) to the time domain signal to generate the DFT-p-OFDM waveform.
